(19) United States
(12) Patent Application Publication
(10) Pub. No.: US 2023/0316203 A1
(43) Pub. Date: Oct. 5, 2023

(54) METHOD FOR MANAGING LABOR

(71) Applicant: BRING YOUR OWN DATA, LLC., d/b/a BYOD, Midland, MI (US)

(72) Inventors: Frank Luijckx, Zurich (CH); Chris Jang, Grand Rapids, MI (US); Mike Costa, Boyne City, MI (US); Dave Dittenber, Midland, MI (US)

(21) Appl. No.: 18/041,620

(22) PCT Filed: Aug. 16, 2021
(86) PCT No.: PCT/US2021/046126

§ 371 Date: Feb. 14, 2023

Related U.S. Application Data
(60) Provisional application No. 63/070,215, filed on Aug. 25, 2020.
(60) Provisional application No. 63/065,529, filed on Aug. 14, 2020.

(51) Int. Cl. G06Q 10/0637; G06Q 10/0631

(52) U.S. Cl. CPC G06Q 10/06375; G06Q 10/063116; G06Q 10/063118

(57) ABSTRACT

A system and methods useful for managing labor, inventory, and/or identifying illness. A system and methods which are able to integrate a variety of data for a workplace to provide projected sales, projected staffing, and recommended staffing actions. A system and methods which are able to help automate management of inventory. A system and methods for identifying the potential presence of illness in one or more individuals.

### CROSS-REFERENCE TO RELATED APPLICATIONS

Applicant claims the benefit of U.S. Provisional Application No.: 63/065,529, filed on Aug. 14, 2020 and U.S. Provisional Application No.: 63/070,215 filed on Aug. 25, 2020, the contents of which are incorporated herein by reference in its entirety.

### FIELD

The present teachings relate to a system and method which may be useful in analyzing data to provided automated recommendations for the hospitality industry. The system may be particularly useful in automatically identifying inventory discrepancies, inventory patterns, and labor and scheduling recommendations. As part of managing staffing, the present teachings relate to a system and method which may predict the presence of an illness. The system and method may be particularly useful in automatically identifying the presence of one or more illnesses before entering a specific environment and managing return of individuals into a specific environment after detecting the potential onset of an illness.

### BACKGROUND

The hospitality industry, including restaurants, works with a variety of systems each day. From point-of-sale systems, to manual data entry via customized databases, scheduling and attendance systems, inventory and ordering systems or web portals, and the like. Those in the hospitality industry also heavily rely on information from outside sources that they search and access, such as events databases, weather databases, and so forth. These outside sources may provide an insight as to ebbs and flows in customers and potential customer likes, dislikes, and budgets. Individuals may use this information to try and appropriate staff their facilities and have adequate inventory, without being over staffed or over purchasing inventory. A main challenge is that this requires access to multiple systems, requires a user making decisions based on the data they are able to access and collect, is not real-time (usually forecasting 2 weeks to 2 months out) and may still lead to over or under supply of inventory and staffing and thus unnecessary businesses expenses.

Additionally, the past few years due to COVID-19, the hospitality industry has faced a number of challenges impacting day-to-day operations and management. These challenges including staffing shortages, rising wages, theft, inexperienced management, lack of usable data to make informed operational decisions, and inability to access real-time analytics. Staffing shortages may be due to unexpected peaks in customers and business hours that were not experienced prior to the COVID-19 pandemic. For example, a lunch-time crowd may have been the peak for a downtown business, but with businesses emphasizing remote work, the new peak hours may be evenings or Sunday mornings for local residents. Due to the competitive market, wages have been increasing. With increased wages, overstaffing has a more significant impact on the business. Due to the COVID-19 pandemic and the new reality in the hospitality industry, there is a lot of movement in management positions. These inexperienced individuals may not know where to access data to make informed decisions regarding inventory, labor, and the like.

Thus, what is needed, is a system which can automate, predict, and even recommend a number of operational decisions. What is needed is a system which can automatically detect discrepancies or deviations from expected operations.

Recent viral infections and illnesses have caused a significant impact in work environments. As some new viruses with unknown long-term consequences are discovered and transmitted, protocols for safety and avoiding transmission are developed and put in place. While historically, it may have been acceptable behavior to attend work, school, and other functions while feeling under the weather, these viruses are changing societal norms. It is now expected that individuals stay home while feeling ill to avoid transmission of viruses and other pathogens, and thus avoid causing serious and even fatal illnesses in other individuals.

One example of such a virus is the SARS-CoV-2 virus which can lead to individuals having COVID-19. In some regions and states, strict protocols have been implemented to screen employees for the presence of the virus and/or its symptoms before entering the workplace. If one or more symptoms are present, the employees are expected to return home and self-quarantine for a certain period of time, seek medical attention, or even receive confirmation from a virus detection test (e.g., viral cultures, rapid diagnostic testing). While these screening methods may seem simple, they become cumbersome to administrate and rely on the honesty of individuals. Additionally, there may be auditing requirements by licensing agencies and other offices to ensure employers are performing adequate screening. The recordkeeping and paperwork associated with such screening is generally impractical in typical workplaces.

Some environments are especially sensitive and susceptible to the transmission of pathogens. These environments may be indoors, rely on face-to-face interaction, require frequent contact with same surfaces, and the like. These environments may be work environments, educational environments, hospitality environments, medical environments, and the like. The hospitality industry is one industry significantly impacted by protocols to avoid pathogen transmissions. The hospitality industry may include restaurants, hotels, casinos, amusement parks, events, cruises, entertainment, other tourism related services, and the like.

What is needed is a system and method which can easily screen individuals for the presence or potential presence of one or more pathogens and/or illnesses before entering a specific environment. What is needed is a system and method which can establish acceptable return dates for individuals after the onset of viral symptoms and/or detection of a potential illness. What is needed is a system and method which can simplify monitoring and adherence to return dates by individuals. What is needed is a system and method which can easily collect data related to individuals and consolidate into records associated with the individuals.

### SUMMARY

The present teachings relate to a computer-implemented method for managing labor for a workplace with a labor module including: a) executing a sales sub-module and automatically determining projected sales for the workplace; b) transmitting the projected sales to a labor sub-module; c) executing the labor sub-module determining projected staffing needs; d) transmitting the projected staffing needs to a scheduling sub-module; and e) executing the scheduling sub-module and determining one or more recommended staffing actions.

The present teachings relate to a computer-implemented method for managing inventory with an inventory module comprising: a) executing an order guide sub-module to generate one or more order guides; b) executing an inventory balance sub-module to determine a current inventory balance; c) executing a transaction sub-module for storing one or more transaction documents in a standardized format; and/or d) executing one or more invoice quality sub-modules to identify a presence and/or absence of one or more discrepancies in invoices.

The present teachings relate to a method for identifying the presence of one or more illnesses in an individual comprising: a) presenting the individual with one or more questions via one or more user interfaces; b) receiving one or more answers from the individual to the one or more questions via the one or more user interfaces; c) receiving a bodily temperature reading of the individual from a temperature sensing device; d) identifying the presence and/or absence of the one or more illnesses in the individual; e) informing the individual of the presence and/or the absence of the one or more illnesses via the one or more user interfaces.

The present teachings relate to a method of identifying the presence of one or more illnesses in an individual comprising: A method for identifying the presence of one or more illnesses in an individual comprising: a) logging into an account associated with the individual one or more user interfaces; b) searching for a presence of a return date associated with the individual; c) comparing the return date to a current date and making an initial determination based on the comparison; d) presenting the individual with one or more questions via one or more user interfaces; e) receiving one or more answers from the individual to the one or more questions via the one or more user interfaces; f) receiving a bodily temperature reading of the individual from a temperature sensing device; g) identifying the presence and/or absence of the one or more illnesses in the individual; and h) informing the individual of the presence and/or the absence of the one or more illnesses via the one or more user interfaces.

The present teachings provide for a system and method which is able to collect to a variety of hospitality management systems and collect respective data. The presenting teachings provide for a system which is able to provide functionality across a breadth of a hospitality business’ functions (e.g., sales forecasting, staff forecasting, timekeeping, inventory management, illness management, compliance, etc.). The present teachings provide for a system which can automate, predict, and recommend a number of operational decisions. The present teachings provide a system and method which can automatically detect discrepancies or deviations from expected operations.

The present teachings provide for a system and method which can easily screen individuals for the presence or potential presence of one or more pathogens and/or illnesses before entering a specific environment. The system and method may use a variety of inputs for screening, including questions regarding symptoms, travel, bodily temperature, previously established return dates, previous records, the like, or any combination thereof. The present teachings provide a system and method which can establish acceptable return dates for individuals after the onset of viral symptoms and/or detection of a potential illness. The present teachings provide a system and method which can simplify monitoring and adherence to return dates by individuals. The present teachings provide a system and method which can easily collect data related to individuals and consolidate into records associated with the individuals. The present teachings provide a system and method which can simplify contact tracing in the case of an individual becoming ill.

### BRIEF DESCRIPTION OF DRAWINGS

FIG. 1 illustrates a macro architecture of a system.

FIG. 2 illustrates a method for identifying and managing illness.

FIG. 3 illustrates a graphical user interface with a log-in interface.

FIG. 4 illustrates a graphical user interface with a question interface.

FIG. 5 illustrates a graphical user interface with a temperature interface.

FIG. 6 illustrates a graphical user interface with a certification interface.

FIG. 7 illustrates a graphical user interface displaying an analytics interface.

FIG. 8 illustrates a network of the system.

FIG. 9 illustrates a graphical user interface displaying a management scheduling interface.

FIG. 10 illustrates a graphical user interface displaying a shift scheduling interface.

FIG. 11 illustrates a graphical user interface displaying a cover request interface.

FIG. 12 illustrates a graphical user interface displaying an employee scheduling interface.

FIG. 13 illustrates a graphical user interface displaying a shift trade interface.

FIG. 14 illustrates a graphical user interface displaying a time-off request interface.

FIG. 15 illustrates a graphical user interface displaying a labor trend interface.

FIG. 16 illustrates a graphical user interface displaying an individual work completion interface.

FIG. 17 illustrates a graphical user interface displaying an employee work completion interface.

FIG. 18 illustrates a graphical user interface displaying a sales impact interface.

FIG. 19 illustrates an architecture of the system.

FIG. 20 illustrates an architecture of the system.

FIG. 21 illustrates a labor module.

FIG. 22 illustrates a scheduling database.

FIG. 23 illustrates an order guide sub-module of an inventory module.

FIG. 24 illustrates an inventory balance sub-module of an inventory module.

FIG. 25 illustrates an inventory transaction sub-module of an inventory module.

FIG. 26 illustrates an invoice quality sub-module.

FIG. 27 illustrates an invoice quality sub-module.

FIG. 28 illustrates a visual monitoring configuration of the system.

FIG. 29 illustrates a method of conducting visual monitoring with the system.

FIG. 30 illustrates a method for configuring a system and method for identifying and managing illness.

FIG. 31 illustrates a registered user interface.

FIG. 32 illustrates a new user input interface.

FIG. 33 illustrates a permissions interface.

FIG. 34 illustrates a permissions type interface.

FIG. 35 illustrates a roles interface.

FIG. 36 illustrates a designated environment interface.

FIG. 37 illustrates an environment type interface.

FIG. 38 illustrates a checklist design interface.

FIG. 39 illustrates a method for identifying and managing the presence of one or more illnesses in an individual.

FIG. 40A illustrates a portion of a method for identifying and managing the presence of one or more illnesses in an individual.

FIG. 40B illustrates a portion of a method continued from FIG. 40A for identifying and managing the presence of one or more illnesses in an individual.

FIG. 41 illustrates a method for identifying and managing the presence of one or more illnesses in an individual.

FIG. 42 illustrates a method for identifying and managing the presence of one or more illnesses in an individual.

FIG. 43 illustrates a method for identifying and managing the presence of one or more illnesses in an individual.

FIG. 44 illustrates a graphical user interface displaying a dashboard interface.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

### System for Managing Labor, Inventory, and Overall Business Decisions

The system may include one or more applications. The application (i.e., “computer program”) may function to execute the methods of the present disclosure. The application may be stored on one or more memory storage devices. The application may comprise and/or be in communication with one or more computer-executable instructions, modules, algorithms, rules, processes, methods, user interfaces, menus, databases, the like, or any combination thereof. The computer-executable instructions, when executed by a computing device may cause the computing device to perform one or more methods described herein. The application may be downloaded, accessible without downloading, or both. The application may be downloadable onto one or more computing devices. The application may be downloadable from an application store (i.e., “app store”), a website, or both. An application store may include, but is not limited to, Apple App Store, Google Play, Amazon Appstore, or any combination thereof. The applicable may be accessible without downloading onto one or more computing devices. The application may be accessible via one or more web browsers. The application may be accessible as a website. The application may interact and/or communication through one or more interaction interfaces. The application may be utilized by one or more computing devices. The application may be utilized on one or more computing devices. The application may also be referred to as a dedicated application.

One or more computing devices may include one or more user interfaces. The one or more user interfaces may function to display information to an individual, receive inputs from a user, or both. The one or more user interfaces may be suitable for receiving data from a user. The one or more user interfaces may include one or more graphical user interfaces (GUI), audio interfaces, image interfaces, the like, or any combination thereof. One or more graphical user interfaces may function to display visual data to a user, receive one or more inputs from the user, or both. The one or more graphical user interfaces may include one or more screens. The one or more screens may be a screen located on a computing device. The one or more screens may be a screen on a mobile computing device, non-mobile computing device, or both. The one or more graphical user interfaces may include and/or be in communication with one or more user input devices, audio interfaces, image interfaces, the like, or any combination thereof. The one or more user input devices may allow for receiving one or more inputs from a user. The one or more input devices may include one or more buttons, wheels, keyboards, switches, mice, joysticks, touch pads (i.e., a touch-sensitive area, provided as a separate peripheral or integrated into a computing device, that does not display visual output), touch-sensitive monitor screens, microphones, the like, or any combination thereof. The one or more input devices may be integrated with a graphical user interface. An audio interface may function to project sound to a user and/or receive sound from a user. The audio interface may include audio circuitry, one or more speakers, one or more microphones, the like, or any combination thereof. An image interface may function to capture, receive, display, and/or transmit one or more images. An image interface may include one or more cameras. A user interface may function to display and/or navigate through one or more interfaces and menus of the application.

One or more user interfaces may include a plurality of user interfaces. A plurality of user interfaces may allow for one or more users to interact with the system at differing locations. A plurality of user interfaces may include at least a first user interface and a second user interface. A first user interface may be part of a first computing device. A second user interface may be part of a second computing device.

The system may include one or more computing devices. The one or more computing devices may function to allow a user to interact with an application; execute one or more modules, algorithms, methods, and/or processes; receive and/or transmit one or more data signals, convert one or more data signals to data entries, retrieve one or more data entries from one or more storage devices, or any combination thereof. The one or more computing devices may include and/or be in communication with one or more processors, storage devices, servers, networks, user interfaces, other computing devices, the like, or any combination thereof. The one or more or more computing devices may communicate via one or more interaction interfaces (e.g., an application programming interface (“API”)), networks, and/or the like. The computing device may be one or more personal computers (e.g., laptop or desktop), mobile devices (e.g., mobile phone, tablet, smart watch, etc.), or any combination thereof. The computing device may include or be in communication with one or more point-of-sale systems, time keeping and/or scheduling systems, inventory systems, thermal scanning systems, the like, or any combination thereof. One or more computing devices may include a single or a plurality of computing devices. A plurality of computing devices may be located within a same environment, separate environments, or both. A plurality of computing devices may include at least a first computing device and a second computing device. A first computing device may be located separate from a second computing device. A first computing device may include a personal computer, mobile device, or both of a user. A second computing device may include a personal computer, mobile device, point of sale system, timekeeping system, inventory system, thermal scanning system, and/or the like. A second computing device may be located in a designated environment. The environment may be a work, school, and/or hospitality environment associated with the user. For example, the environment may be the work environment (e.g., employer) of the user.

The system may include one or more servers. One or more servers may function to transmit, receive, store, convert, or any combination thereof data from one or more applications, modules, computing devices, etc. to one or more other servers, browsers, computing devices, modules, and/or the like. The one or more servers may function to complete one or more processes of one or more applications. The one or more servers may function to execute one or more instructions. The one or more servers may function to receive input from and/or transmit output to the one or more applications. The one or more servers may include one or more physical servers, virtual servers, or a combination of both. The one or more servers may be non-transient. One or more servers may include one or more local servers, remote servers, or both. The one or more servers may include one or more emails servers, web servers, or a combination thereof. The one or more servers may include one or more motherboards, processors, storage devices, drives, communication modules, the like, or any combination thereof.

The system may include one or more processors. The one or more processors may function to analyze one or more signals and/or data from one or more user interfaces, computing devices, modules, sensing devices, memory storage devices, databases, or any combination thereof; convert one or more signals to data suitable for analysis and/or saving within a database (e.g., data conversion, data cleaning); access one or more computer executable instructions, modules, or both or a combination thereof. The one or more processors may be located in one or more sensing devices, user interfaces, computing devices, the like, or any combination thereof. The one or more processors may or may not be cloud-based (e.g., remote from other portions of the system). One or more processors may include a single or a plurality of processors. One or more processors may be in communication with one or more other processors. The one or more processors may function to process data, execute one or more algorithms to analyze data, or both. Processing data may include receiving, transforming, outputting, executing, the like, or any combination thereof. One or more processors may be part of one or more hardware, software, systems, or any combination thereof. One or more hardware processors may include one or more central processing units, multi-core processors, front-end processors, the like, or any combination thereof. The one or more processors may be non-transient. The one or more processors may be referred to as one or more electronic processors. The one or more processors may convert data signals to data entries to be saved within one or more storage devices. A data signal may be a signal associated with an input from a user interface. A data entry may be an entry stored within one or more databases. The one or more processors may access one or more algorithms, processes, and/or methods to analyze one or more data entries and/or data signals. The one or more processors may access one or more algorithms saved within one or more memory storage devices. The one or more processors may execute one or more methods for identifying the presence of one or more illnesses in an individual, establishing one or more return dates, preventing access of an individual to a designated environment, the like, or any combination thereof. The one or more processors may execute the one or more methods, processes, and/or algorithms via one or more algorithms stored within and accessible from one or more memory storage devices; data stored within and accessible from one or more databases; or both.

The system may include one or more memory storage devices (e.g., electronic memory storage device). The one or more memory storage devices may store modules, data, databases, algorithms, processes, methods, the like, or any combination thereof. The one or more memory storage devices may include one or more hard drives (e.g., hard drive memory), chips (e.g., Random Access Memory “RAM)”), discs, flash drives, memory cards, the like, or any combination thereof. One or more discs may include one or more floppy diskettes, hard disk drives, optical data storage media including CD ROMs, DVDs, and the like. One or more chips may include ROMs, flash RAM, EPROMs, hardwired or preprogrammed chips, nanotechnology memory, or the like. The one or more memory storage devices may include one or more cloud-based storage devices. The data stored within one or more memory storage devices may be compressed, encrypted, or both. The data stored within one or more memory storage devices may comply with health privacy regulations (e.g., Health Insurance Portability and Accountability Act). The one or more memory storage devices may be located within one or more sensing devices, computing devices, one or more processors, one or more user interfaces, or any combination thereof. One or more memory storage devices may be referred to as one or more electronic memory storage devices. One or more memory storage devices may be non-transient. One or more memory storage devices may store one or more data entries in a native format, foreign format, or both. One or more memory storage devices may store data entries as objects, files, blocks, or a combination thereof. The one or more memory storage devices may include one or more modules, methods, algorithms, rules, databases, data entries, the like, or any combination therefore stored therein. The one or more memory storage devices may store data in the form of one or more databases.

One or more computing devices may include one or more databases. The one or more databases may function to receive, store, and/or allow for retrieval of one or more data entries. The data entries may be values associated with one or more detected signals; results from one or more algorithms, processes, rules, and/or methods; or any combination thereof. The one or more databases may be located within one or more memory storage devices. The one or more databases may include any type of database able to store digital information. The digital information may be stored within one or more databases in any suitable form using any suitable database management system (DBMS). Exemplary storage forms include relational databases (e.g., SQL database, row-oriented, column-oriented), non-relational databases (e.g., NoSQL database), correlation databases, ordered/unordered flat files, structured files, the like, or any combination thereof. The one or more databases may store one or more classifications of data models. The one or more classifications may include column (e.g., wide column), document, key-value (e.g., key-value cache, key-value store), object, graph, multi-model, or any combination thereof. One or more databases may be located within or be part of hardware, software, or both. One or more databases may be stored on a same or different hardware and/or software as one or more other databases. One or more databases may be located in a same or different non-transient storage device as one or more other databases. The one or more databases may be accessible by one or more processors to retrieve data entries for analysis via one or more algorithms, methods, rules, processes, or any combination thereof. The one or more databases may include a single database or a plurality of databases. One database may be in communication with one or more other databases. One or more databases may be connected to one or more other databases via one or more networks. For example, a database of the system may be in communication with one or more other databases via the Internet. The one or more databases may receive and store one or more inputs into the system, outputs from the system, or both. The one or more inputs may include environment (e.g., workplace), roles, permissions, user names, passwords, questions, answers, body temperature readings, date of logging in, external inputs, calendar inputs, workplace inputs, staff profile inputs, projected sales, projected staffing needs, staff actions, schedule inputs, manual order guides, machine received order guides, inventory information, machine received transaction documents, manually received transaction documents, sensed data from sensing devices, the like, or any combination thereof. The outputs may include the presence and/or absence of an illness and/or associated symptoms, a return date, projected sales, projected staffing needs, staff actions, normalized data, order guide(s), inventory balance, transaction documents, comparisons, discrepancies, the like, or both. The one or more databases may be able to have the data outputted, sorted, filtered, analyzed, the like, or any combination thereof. For example, data within the database may be able to be analyzed to determine one or more trends, deviations, variability, conditions, the like, or any combination thereof. The one or more databases may be able to have data anonymized before outputting. The one or more databases may include one or more environment databases, user databases, role databases, permissions databases, symptom databases, user input databases, sales databases, labor databases, scheduling databases, order guide databases, transaction databases, inventory databases, the like, or any combination thereof. The database may be suitable for storing a plurality of records.

One or more databases may include one or more records. The one or more records may function to store one or more data entries associated with one or more users. A record may include one or more data entries associated with one or more signals. The one or more signals may be collected via a user interface after an initial log-in of a user upon visiting the application. A user may be associated with a user identification key. One or more records in one or more databases may be filtered by a user identification key or other data entry to execute one or more modules, algorithms, processes, rules, or any combination thereof related to the user. One or more algorithms, methods, and/or processes may filter the data for a specific user by a user identification key to provide for a return date, diagnosis, or both related to that user.

The system of the present disclosure may be integrated and/or include one or more networks. The computing devices may be in selective communication with one or more networks. The one or more networks may be formed by placing two or more computing devices in communication with one another. One or more networks may include one or more communication hubs, communication modules, computing devices, processors, databases, servers, memory storage devices, sensing devices, the like, or any combination thereof. One or more networks may be free of and/or include one or more communication hubs (e.g., router, wireless router). One or more computing devices of the system may be directly connected to one another without the use of a communication hub. One or more networks may be connected to one or more other networks. One or more networks may include one or more local area networks (“LAN”), wide area networks (“WAN”), virtual private network (“VPN”), intranet, Internet, cellular networks, the like, or any combination thereof. The network may be temporarily, semi-permanently, or permanently connected to one or more computing devices, or any combination thereof. A network may allow for one or more computing devices to be connected to the computing device to transmit one or more data signals to the one or more computing devices, receive one or more data signals from the one or more computing devices, or both. The network may allow for one or more computing devices to receive one or more data entries from and/or transmit one or more data entries to one or more storage media. The network may allow for transmission of one or more signals, status signals, data entries, instruction signals, or any combination thereof, for processing by one or more processors.

The system may include, connect to, or be free of one or more sensing devices. The one or more sensing devices may function to detect one or more individuals, changes in conditions of a workplace (e.g., environment) and/or equipment, monitor a workplace and/or equipment, detect one or more vital signals, detect one or more physiological signals, the like, or any combination thereof. The one or more sensing devices may be wired, wireless, noncommunicative, or any combination thereof. Wired may mean that the one or more sensing devices are in direct electrical communication with an electronic processor, memory storage device, user interface, or a combination thereof via one or more wires such that signals received by the one or more sensing devices are transmitted via the one or more wires. Wireless may mean that the one or more sensing devices are not physically connected to the electronic process, memory storage device, user interface, or a combination thereof and may transmit the signals received by one or more wireless modes of communication. Wireless modes may include Wi-Fi, Bluetooth®, NFC, and the like. Noncommunicative may mean that the sensing device is not in communication with any components of the system, a user relies on an output of the sensing device, a user enters the output of the sensing device into the application (e.g., using the user interface), or any combination thereof. One or more sensing devices may include any device capable of detecting and measuring one or more vital signals, physiological signals, or any combination thereof of a human or other animal. One or more sensing devices may include any device capable of monitoring and/or detecting a work environment, equipment, and/or the like. One or more sensing devices may be included, separate from, or both one or more user computing devices, medical facility computing devices, or both. One or more sensing devices may include one or more motion sensors, video cameras, photographic cameras, temperature sensors, heart rate sensors, the like, or any combination thereof. One or more temperature sensors may include one or more manual and/or digital thermometers. One or more temperature sensors may be contact and/or non-contact. One or more temperature sensors may be handheld, freestanding, or both. One or more temperature sensors may be a full body temperature scanning system. One or more temperature sensors may include a handheld, digital, and non-contact thermometer. One or more heart rate sensors may include one or more optical heartbeat sensors. Optical heartbeat sensors may be integrated into wearable accessories (e.g., ring, watch), mobile devices (e.g., mobile phone, tablet), and the like.

The system may include and/or be in communication with one or more communication platforms. The one or more communications platforms may function to generate one or more automatic communications based on one or more activities within the application. One or more activities within the application may generate one or more real time actions with the one or more communication platforms. One or activities may include one or more individual entries, logbook entries, checklist entries, lack of entry within a logbook and/or checklist, the like, or a combination thereof. The one or more communications platforms may include Slack, Microsoft Teams, Google Hangouts, Happeo, Chanty, the like, or any combination thereof, incorporated by reference herein. The one or more activities may include actions required, deadlines, responsible parties, the like, or any combination thereof.

The system may include one or more modules. The one or more modules may function to provide one or more designated environments with a means of managing a workplace, including managing labor, managing inventory, and managing and identifying the presence of illness in their environments. The one or more modules may be software part of the application. The one or more modules may be executable computer instructions residing on one or more storage mediums. The one or more modules may be accessed and executed by one or more processors. The one or more modules may cooperate with one another, one or more applications residing within the same system, one or more applications part of a different system, or any combination thereof. One or more modules may be in direct and/or indirect communication with one another. One or more modules may be in communication with one or more other modules and/or applications via one or more application programming interfaces (“API”), over the network, within the same system, via one or more databases, the like, or any combination thereof. The one or more modules may allow for checklists, logbooks, actions, alerts, order guides, inventory recommendations, the like, or any combination thereof. The one or more modules may include one or more checklist modules, logbook modules, action modules, illness detection modules, client reporting module, compliance reporting module, regulations module, authority knowledge module, labor module, inventory module, the like, or any combination thereof.

The system may include an illness detection module. The illness detection module may function to manage and identify the presence of an illness in an individual. The illness detection module may provide a means for individuals to be evaluated for exposure to one or more risks, exhibiting one or more symptoms, or both of an illness. The illness detection module may be the module a user sees via a graphical user interface. The user may be an employee and/or guest of a designated environment. The illness detection module may include a screening process. The screen processing may include the log-in interface, question interface, temperature interface, and/or certification interface.

The system may include a checklist module. The checklist module may function to create and manage one or more checklists, questions, and/or surveys. The checklist module may allow for one or more users create the questions and/or items to be presented in the one or more checklists, questions, and/or surveys. The checklist module may allow for one or more users to create standardized operating procedures presented in checklist form. The one or more checklists, questions, and/or surveys may be viewable and interactable via one or more user interfaces (e.g., graphical user interface). The checklist module may allow for users to import one or more questions and/or items from one or more government authorities, licensing authorities, health organizations, and/or other health experts. For example, one or more benchmark questions may already be established for identifying a risk and/or symptom of an illness. The user may be able to import the one or more benchmark questions. The user managing the checklist module may be an administrator and/or manager associated with a designated environment. A checklist module may present one or more checklists, questions, and/or surveys to a user via one or more graphical user interfaces. The checklist module may allow for one or more users to complete the one or more checklists, questions, and/or surveys via the graphical user interface. The checklist module may communicate completion, progress, or both of one or more users to one or more other modules, such as a labor module, logbook module, or both.

The system may include an action module. The action module may function to identify one or more activities (e.g., tasks, alerts) to be completed, responsible parties, deadlines, the like, or any combination thereof. The one or more activities may be generated from one or more illness detection modules, checklist modules, logbook modules, labor modules, inventory modules, other modules, and/or the like. For example, if a user is identified via the illness detection module as exhibiting one or more symptoms, one or more activities may be generated. One or more activities may include notifying individuals that they may have been in contact with or exposed to the individual, sanitizing the designated environment, the like, or any combination thereof. As another example, if a labor module results in one or more recommended staffing actions, the one or more recommended staffing actions may be transmitted to the action module from the labor module, and the one or more recommended staffing actions may be displayed on a graphical user interface. As a further example, if a labor module results in one or more inventory recommendations and/or discrepancies, the recommendations and/or discrepancies may be transmitted to the action module from the inventory module, and then displayed as one or more actions (e.g., tasks or alerts) on a user’s graphical user interface.

The system may include a logbook module. The logbook module may function to log activities by one or more users. The activities may be related to the illness detection module, checklist module, action module, labor module, inventory module, and/or other modules. The activities may include one or more items from a checklist, survey, and/or question from the checklist module. The activities may include one or more items from one or more alerts and/or tasks from a logbook module. The activities may be marked with a responsible user, completion status, date, and/or time. The activities may be generated from an illness module, checklist module, action module, inventory module, labor module, and/or other modules. The activities, completion thereof, present status, and/or the like may be transmitted to one or more labor modules for then viewing completion progress.

The system may include a client reporting module. The client reporting module may provide for easy reporting of activities within the application. The client reporting module may allow each designated environment to generate summaries of registered users tied to their environment. The client reporting module may allow for users to generate one or more analytics interfaces.

The system may include a compliance reporting module. The compliance reporting module may provide for easy auditing for compliance with one or more regulations. The compliance reporting module may provide detailed and summary outputs of data input into the system by one or more users, may break down the inputs by designated environment, or both.

The system may include a regulations module. The regulations module may allow for inputting of one or more regulations into the system to be complied with by the one or more designated environments. The regulations may be in place via one or more government authorities, licensing authorities, health organizations, and/or other health experts.

The system may include an authority knowledge module. The authority knowledge module may allow for inputting one or more best practices for operating designated environments. The best practices may be those best practices provide by government authorities, licensing authorities, health organizations, health experts, and the like. Best practices may be additional to or in excess of regulations.

The system may include a labor module. The labor module may function to automatically generate staffing schedules, provide staffing alerts, show attendance, provide real-time recommendations for staffing changes, determine employee performance, learn employee habits, allow for quick and automated staffing changes, and the like. The labor module may include a sales sub-module, labor sub-module, scheduling sub-module, the like, or any combination thereof. The labor module may receive data from one or more external sources. External sources may include one or more weather databases, events databases, calendar databases, schedule databases, the like, or any combination thereof.

The labor module may include a sales sub-module. A sales sub-module may function to determine projected sales. A sales sub-module may function to automatically determine projected sales based on one or more external inputs. The sales sub-module may be one or more algorithms residing on one or more computing devices, memory storage devices, or both. The sales sub-module may access one or more algorithms stored on one or more storage devices. The sales sub-module may include one or more projected sales algorithms. The one or more projected sales algorithms may function to determine projected sales for a workplace. The projected sales for a workplace may include expected volume of sales, expected timeframe (e.g., days, hours) for sales, expected volume of sales by good and/or service offered by a workplace, the like, or any combination thereof. The one or more projected sales from a sales sub-module may function as input into a labor sub-module, scheduling sub-module, or both.

The sales sub-module may be in communication with and/or otherwise receive one or more external inputs. The sales sub-module may be in communication with one or more external inputs such as via one or more application programming interfaces (“APIs”). The sales sub-module may be in a push and/or pull communication relationship with the one or more external inputs. The sales sub-module may include one or more external input algorithms stored therein. The one or more external input algorithms may instruct one or more processors associated with the sales sub-module to pull data from one or more external inputs, receive pushed data from one or more external inputs, or both. The one or more external inputs may include one or more events databases, weather databases, promotions databases, the like, or a combination thereof. The one or more external inputs may be one or more web portals and/or databases accessible via the Internet, stored within the system and accessible by the sales sub-module, or otherwise electronically accessible.

One or more weather databases may be one or more databases, APIs, web portals, and/or the like which provide weather related information. Weather related information can include current weather, past weather, forecasted weather (e.g., 1 day, 3 day, 1 week, 2 week, 1 month forecast), historical trends, and the like. Weather related information may be provided based on a location of a workplace and/or venue. Exemplary weather databases may include or be accessible via AccuWeather Data API by AccuWeather Inc. and Weather API by Meteomatics.

One or more events databases may be one or more databases, APIs, web portals, and/or the like which provide event related information. Event related information can include scheduled events occurring within a certain proximity of a workplace or venue which may impact sales. Events may include concerts, sports games, political gatherings, theatrical performances, conferences, the like, or a combination thereof. One or more events may be located within 1 km or greater, 1.5 km or greater, 2 km or greater, 5 km or greater, 10 km or greater, 20 km or greater, 50 km or greater, 75 km or greater, or even 100 km or greater from a workplace or venue. Event information may be acquired from online events databases such as Eventbrite, Ticketleap, TicketMaster, the like, or a comparison. Exemplary event databases may be accessible or include Eventbrite API by Eventbrite and Ticketmaster API by Ticketmaster.

One or more promotions databases may be one or more databases, APIs, web portals, and/or the like which provide promotions related information. Promotions may include promotions and/or programming being coordinated by one or more organizations to help market one or more businesses. Exemplary promotions include Detroit Restaurant Week, Fine Dining Week, Diversity Month, Pastry Week, and the like. These promotions may target specific audiences, highlight specific sectors of businesses, and/or the like. One or more promotions may released via the online news websites, organizational websites and/or calendars, social media web-based calendars, web-based community calendars, email, email-based electronic calendars, the like, or a combination thereof. One or more promotions may be accessed via one or more APIs. One or more promotions may be received by a user interface of the system. For example, one or more users associated with an organization coordinating a promotion may log-in and upload the promotion details. Promotion details may include the date or dates, times, the name of the promotion, a description of the promotion, the geographic location or range of the promotion (e.g., address, neighborhood, city, county, state, etc.), the type of workplace the promotion relates to (e.g., restaurants, fine dining, burgers, etc.), if a discount is associated with the promotion, if certain requirements are associated with the promotion, the like, or any requirement thereof.

One or more calendar inputs may be one or more databases, APIs, web portals, and/or the like which provide calendar related information. Calendar related information may include information as to the year, month, week, day, seasons, holidays, the like, or any combination thereof. The labor module may use calendar related information to analyze if it may be a low season or a peak season for customers and sales; if holidays may lead to lower or higher sales; if days of the week, weeks, months, or years result in sales trends; the like; or a combination thereof. The one or more calendar inputs may be accessed via one or more APIs, one or more databases part of the system and in communication with the labor module, be otherwise accessible, or any combination thereof. The one or more labor modules may save historical sales data with calendar related information. The one or more labor modules may determine one or more trends in sales based on historical sales data and calendar related information.

One or more workplace inputs may be one or more database, APIs, web portals, and/or the like which provide workplace related information. Workplace related information may include workplace type, workplace location, information about goods for sale, information about services offered, the like, or any combination thereof. Workplace type may include what type of goods and/or services the workplace offers to customers. Workplace types may include differing sectors of the hospitality industry. Workplace type may include types such as restaurants, vehicle repair shops, apparel stores, sports equipment stores, banks, hotels, the like, or any combination thereof. Workplace types may be further categorized mased on hospitality industry. For example, a workplace type may be a restaurant. Then a restaurant type may be further specified. Restaurant types may include the type of experience a restaurant offers to a customer. Exemplary restaurant types may include Mexican, Chinese, Italian, Seafood, Breakfast, Dinner, Lunch, Take-Out, Dine-In, Fine Dining, Burgers, Sports Bar, the like, or any combination thereof. A workplace may be categorized as more than one workplace type. Workplace location may include a physical location of a workplace; a geographic range, zone, or area of a workplace; the like; or a combination thereof. A physical location of a workplace may include a street address, city, state, and zip code. A geographic range, zone, or area of a workplace may include a district in which the workplace is located (e.g., downtown, midtown, uptown, etc.); a neighborhood in which a workplace is located; a metro area in which the workplace is located (e.g., Metro-Detroit, Mid-Michigan, etc.); the like; or a combination thereof. The one or more workplace inputs may be accessed via one or more APIs, one or more databases part of the system and in communication with the labor module, be otherwise accessible, the like, or any combination thereof.

The labor module may include a labor sub-module. A labor sub-module may function to determine projected staffing needs. Projected staffing needs may include the mix of employees/staffing by role needed to support the projected sales, may identify specific employees best suited for filling the needed roles, the like, or both. The labor sub-module may receive input from the sales sub-module, one or more staff profile inputs, the like, or a combination thereof. The labor sub-module may include one or more labor algorithms. The one or more labor algorithms may function to determine projected staffing needs for a workplace. The projected staffing needs may include the number of employees needed on specific days and times, the specific roles needing to be filled during specific days and times, recommendations of specific individual employees to fill the specific roles, hours for the proposed schedule, the like, or any combination thereof. The projected staffing needs may be forecasted out over a period of time. The projected staffing needs may be forecasted for a duration of time. The period of time and/or duration of time may be 1 day or greater, 3 days or greater, 5 days or greater, 1 week or greater, 2 weeks or greater or even 1 month or greater. Forecasting out period of time may be the difference between the day the labor sub-module is executed and when the projected staff needs commence (e.g., starting 2 weeks from today). The duration may be the time frame the projected staffing needs are forecasted for (e.g., for 2 weeks starting on Sep. 1, 2021).

The labor sub-module may be in communication with and/or include one or more staff profile inputs. One or more staff profile inputs may function to create and/or update one or more staff profiles, relay the one or more staff profiles to the labor sub-module, or both. The one or more staff profile inputs may include one or more staff profile databases. The one or more staff profile databases may store one or more staff profiles. The one or more staff profiles may include one or more employee records. The one or more employee records may include information about one or more employees. Information may include the employee’s name, role/roles which the employee is able to fill (e.g., host, waiter, bartender, cook), working preferences of the employee (e.g., weekends, weekdays, evenings, etc.), trends of employee behavior, conclusions about employee behavior, the like, or a combination thereof. The one or more staff profile inputs may be in communication with one or more point-of-sale systems, scheduling systems, and/or the like. The one or more staff profile inputs may determine trends in employee behavior and/or general conclusions about employee behavior by analyzing data from one or more points-of-sale, scheduling systems, or both. For example, the one or more staff profile inputs may determine when an employee receives the best tips (e.g., higher percentages) to conclude when an employee tends to work the best with customers. For example, the one or more staff profile inputs may determine when an employee prefers to work, by noticing trends in the schedule and in shift coverage swaps. As another example, one or more staff profile inputs may determine what type of customer, good, service, and/or role an employee may be best suited for.

The labor module may include a scheduling sub-module. A scheduling sub-module may function to determine one or more recommended staffing actions. Staffing actions may include recommendations for changes in scheduling of employees, business hours, or both. The scheduling sub-module may receive input from the sales sub-module, the labor sub-module, projected staffing needs, one or more scheduling inputs, the like, or a combination thereof. The scheduling sub-module may include one or more scheduling algorithms. The one or more scheduling algorithms may function to determine recommended staffing actions for a workplace. The recommended staffing actions may include changing scheduling of employees, changing roles of which employees are scheduled, swapping employees, adding or reducing hours and/or shifts of employees scheduled, modifying business hours, the like, or any combination thereof. The recommended staffing actions may be provided for the same projected period of time and/or duration of the projected staffing needs. The one or more recommended staffing actions may be transmitted to one or more users of the system. The scheduling sub-module may be in communication with one or more other modules of the system. For example, the scheduling sub-module may be in communication with the action module. The one or more recommended staffing actions may be automatically communicated to one or more action modules. The one or more action modules may then alert a user of one or more recommended staffing actions as determined by the scheduling sub-module.

The scheduling sub-module may be in communication with one or more scheduling inputs. The one or more scheduling inputs may function to create and/or update one or more schedules for a workplace, track time and attendance of employees of a workplace, or both. The one or more scheduling inputs may be associated with one or more schedule inputs, one or more attendance inputs, or both. A schedule input may include one or more schedules created and/or updated internally within the system, externally via one or more scheduling systems, or both. An exemplary scheduling system may include Homebase® by Pioneer Works, Inc. One or more attendance inputs may include information about employee’s starting time, ending time, overall attendance, break times, the like, or a combination thereof. One or more attendance inputs may be received and/or tracked internally within the system, externally via one or more attendance systems, or both. Attendance systems may include one or more point-of-sale systems, clock systems, or both. For example, a point-of-sale system may have built-in timeclock software or the timeclock software may be separate. An exemplary attendance system may include Clover® Point of Sale System by Clover Network, Inc.

The system may include an inventory module. An inventory module may function to create and/or update order guides, determine up-to-date inventory, determine needs in inventory, determine discrepancies between inventory orders (e.g., invoices) and order guides, determine discrepancies between inventory orders (e.g., invoices) and inventory purchasing patterns, make recommendations for ordering inventory, automatically order inventory, the like, or any combination thereof. The inventory module may include an order guide sub-module, an inventory balance sub-module, an inventory transaction sub-module, an invoice quality sub-module, the like, or a combination thereof.

The inventory module may include an order guide sub-module. An order guide sub-module may function to provide templates and guides for ordering inventory of goods, service requests, the like, or a combination thereof. The templates and/or guides may be referred to as order guides. The one or more order guides may include recommendations as to the vendor, the goods or services needed, the amount of goods or services needed, or a combination thereof. The one or more order guides may be created manually, automatically, or both via the order guide sub-module. The order guide sub-module may be in communication with one or more automatic information inputs, manual information inputs, or both. The one or more automatic information inputs may include email information, API information, electronic data interchange (ED) information. The one or more manual information inputs may include one or more forms and/or templates that a user accesses via user interface and uses to create and/or update one or more order guides. Automatic information inputs may be recognized as machine received order guides. Manual information inputs may be recognized as manually received order guides. The order guide sub-module may include one or more normalization algorithms. The one or more normalization algorithms may function to convert the one or more manually received order guides, machine received order guides, or both into data which can be processed. Normalization may include converting images to recognizable characters, adjusting scales of the input, transmitting the received data into one or more order guide databases, structuring a database to store the received data, organizing the received data into columns and tables, recognizing data and transmitting to the desired columns and tables within a database, the like, or a combination thereof. In essence, normalizing the received order guides converts the received data into standard templates and/or forms that can then be utilized as the one or more order guides. The inventory sub-module may be in communication with a backbone and or one or more storage mediums of the system. One or more order guides generated by the order guide sub-module may be automatically transmitted to the backbone and or storage medium.

The inventory module may include one or more inventory balance sub-modules. The inventory sub-modules may function to determine the current balance of inventory; determine inventory trends; determine inventory which may be spoiled, returned, purchased ad-hoc instead of via regular transaction; provide recommendations as to what inventory should be reordered; automatically order needed inventory; the like; or a combination thereof. The one or more inventory balance sub-modules may have one or more inventory algorithms. The one or more inventory algorithms may include one or more current balance algorithms, work-in-process algorithms, and consumed algorithms. For example, if the inventory algorithms are being utilized for restaurant inventory, the current balance algorithm may determine a current balance of unused inventory, the work-in-process algorithm may be a kitchen inventory algorithm to determine the inventory being used in the kitchen, and the consumed algorithm may be a served algorithm which determined the inventory served to guests.

The inventory module may include a transaction sub-module. The transaction sub-module may function to store transactions of a workplace in a standardized format. The transaction sub-module may be in communication with one or more inputs. The one or more inputs may include one or more automatic information inputs, module information inputs, manual information inputs, or a combination thereof. One or more automatic information inputs may include inputs from email information, API information, EDI information, the like, or any combination thereof. One or more module information inputs may include information from any other module part of the system. For example, logbook information for a logbook module. Manual information inputs may include information entered via one or more web portals, user interfaces, forms, the like, or a combination thereof. The inputs may be any information related to any one or more or more transactions impacting inventory at a workplace. For example, the ordering of inventory, the invoicing for inventory, the payment for inventory, and the like. The documents received via the one or more inputs may include one or more purchase/order forms, invoices, receipts, shipping checklists, the like, or a combination thereof. The information whether manually received or machine received may go through normalization. The transaction sub-module may include one or more normalization algorithms. The one or more normalization algorithms may function to convert the one or more transaction documents into data which can be processed. Normalization may include converting images to recognizable characters, adjusting scales of the input, transmitting the received data into one or more transaction databases, structuring a database to store the received data, organizing the received data into columns and tables, recognizing data and transmitting to the desired columns and tables within a database, the like, or a combination thereof. In essence, normalizing the received transaction documents converts the received data into data entries that can then be stored as one or more records within a transaction database. The transaction sub-module may be in communication with a backbone and or one or more storage mediums of the system. One or more transaction records generated by the transaction sub-module may be automatically transmitted to the backbone and or storage medium.

The inventory module may include one or more invoice quality sub-modules. The one or more invoice quality sub-modules may function to compare one or more invoices with one or more inventory order guides, inventory patterns, the like, or a combination thereof. The one or more inventory quality sub-modules may be in communication with the one or more inventory balance sub-modules, order guide sub-modules, transaction sub-modules, the like, or a combination thereof. The one or more invoice quality sub-modules may include one or more invoice matching algorithms, comparison algorithms, alert algorithms, and storage algorithms. The one or more invoice matching algorithms may function to match one or more received invoices with one or more order guides, inventory patterns, the like, or a combination thereof. The one or more comparison algorithms may function to compare one or ore received invoices with one or more order guides, inventory patterns, the like, or a combination thereof. The one or more alert algorithms may function to communicate one or more discrepancies with one or more other modules (e.g., action module), alert a user of the discrepancy, or both. The one or more storage algorithms may function to store the comparisons, learn and update purchasing trends, or both.

### Method for Managing Inventory

The present teachings relate to a method for managing inventory. The method may be computer-implemented. The method may implement or be implemented by an inventory module according to the teachings herein. The method may include executing an order guide sub-module to generate one or more order guides, executing an inventory balance sub-module to determine a current inventory balance, executing a transaction sub-module for storing one or more transaction documents in a standardized format, executing one or more invoice quality sub-modules to identify the presence and/or absence of one or more discrepancies in the invoices, the like, or a combination thereof.

The method may include accessing an inventory module or one or more sub-modules thereof. The inventory module may reside within one or more storage mediums of the system. The inventory module may be accessed by a backbone of the system. The inventory module may be automatically accessed without user interaction. The inventory module may be automatically accessed to initiate the method or may be initiated by a user. Initiated via a user may occur via graphical user interface. The method may be automatically initiated during a predetermined time or upon the occurrence of a predetermined event. The predetermined time may be overnight, during closed hours of a business, during open hours, or any combination thereof. The predetermined event may include a change in inventory, an order being placed (e.g., transaction occurring), an invoice being received, a payment of an invoice being completed, a receipt being received, the like, or any combination thereof. Upon accessing the inventory module, one or more sub-modules may be initiated. One or more sub-modules may include one or more order guide sub-modules, one or more inventory balance sub-modules, one or more transaction sub-modules, one or more invoice quality sub-modules, the like, or any combination thereof.

The method may include executing an order guide sub-module to generate one or more order guides. The order guide sub-module may be automatically accessed, manually accessed, or both. An order guide sub-module upon being accessed may be executed. Executing may open one or more web portals on one or more user interfaces with one or more forms for a user to enter an order guide. Executing may include receiving one or more automatic information inputs, manual information inputs, or both. Receiving may be executed via pushing and/or pulling from the order guide sub-module. Executing may mean accessing one or more email accounts or databases, one or more APIs, one or more EDIs, the like, or a combination thereof. Executing may mean receiving one or more machine received order guides, one or more manually received order guides, or both. Receiving may mean received by one or more processors which are executing the order guide sub-module. After receiving one or more machine received order guides, one or more manually received order guides, or both, a normalization algorithm may be executed. The normalization algorithm may convert the one or more received order guides into data which can be processed, retrieve one or more stored order guide templates, insert the data into one or more order guide templates, the like, or any combination thereof. After the normalization algorithm is complete, one or more order guides may be automatically recorded. Recording may mean inserting order guide data in an order guide template, storing an order guide template with the acquired order guide data, or both. The one or more recorded order guides may be transferred to a backbone of the system, one or more storage mediums, one or more other modules or sub-modules, the like, or any combination thereof.

The method may include executing an inventory balance sub-module to determine a current inventory balance. The inventory balance sub-module may be automatically executed, manually executed, or both. The inventory balance module may execute one or more inventory balance sub-modules. The one or more inventory balance sub-modules may include one or more inventory algorithms. The one or more inventory algorithms may include one or more current balance algorithms, work-in-process algorithms, and consumed algorithms. The one or more inventory balance sub-modules, inventory algorithms, or both may be executed in parallel, in series, or both. One or more of the inventory algorithms may receive data automatically, manually, or both. One or more current balance algorithms may determine a balance of unused (e.g., stored) inventory. The one or more current balance algorithms may receive information regarding deliveries, returns, and/or ad hoc purchases to a workplace. The one or more current balance algorithms may receive information regarding usage, returns, ad hoc purchases by a work-in-process area. The one or more current balance algorithms may add deliveries, returns from work-in process, and ad hoc purchases (deliveries + returns + ad hoc purchases) and subtract returns of unused inventory, usage, and spoilage (-returns - usage - spoilage). Some of the data may be received automatically, such as via one or more invoices, transaction documents, order guides, or a combination thereof. Some of the data may be manually entered, such as one or more ad hoc purchases. The one or more work-in-process algorithms may receive information regarding usage, returns, take-out, spoilage, rejections, consumption, and/or otherwise removed inventory (e.g., takeout direct from a kitchen). The one or more work-in-process algorithms may add (e.g., aggregate) usage, ad hoc purchases, and rejections from a consumption area (e.g., usage + ad hoc purchases + rejections). The one or more work-in process algorithms may subtract (e.g., reduce) returns, spoilage, consumption, other removal of inventory (e.g., -returns - spoilage - consumption - removal). The one or more consumed algorithms may receive information regarding consumption, rejections, removal of partially consumed items, and spoilage. The one or more consumed algorithms may add consumption. The one or more consumed algorithms may subtract partially consumed inventory, returned or spoiled inventory, and rejected inventory. The inventory results of each inventory algorithm may then be added to understand a full scope of an inventory balance within a workplace. Each algorithm may identify an inventory within an area of workplace (e.g., stockroom, kitchen, dining area). The resulting inventory balance may be transmitted by the inventory module to one or more other modules.

The method may include executing a transaction sub-module for storing one or more transaction documents in a standardized format. The transaction sub-module may be automatically executed, manually executed, or both. One or more automatic information inputs may trigger automatic execution of a transaction sub-modules. One or more manual information inputs may initiate manual execution of a transaction sub-module. The transaction sub-module may receive one or more transaction documents via one or more automatic and/or manual information inputs. Receipt may be by one or more processors executing the transaction sub-module. Upon receiving of the one or more transaction documents, one or more normalization documents may be automatically executed. The one or more normalization algorithms may recognize and parse the data within the one or more transaction documents, convert the transaction documents into data which can be further processed by the transaction sub-module, or both. After executing one or more normalization algorithms, the transaction document data may then be converted into one or more transaction data entries. The one or more transaction data entries may then be stored (e.g., recorded) into one or more transaction databases. The one or more transaction records, entries, and/or databases may be stored within one or more storage mediums, a backbone of the system, and/or the like. The one or more transaction records may be transmitted to one or more other modules and/or sub-modules. For example, one or more transaction records may be transferred to one or more invoice quality sub-modules.

The method may include executing one or more invoice quality sub-modules to identify the presence and/or absence of one or more discrepancies in the invoices. The invoice quality sub-module may be automatically executed, manually executed, or both. One or more automatic inputs may trigger automatic execution of one or more invoice quality sub-modules. One or more automatic inputs may include one or more transaction records from one or more transaction sub-modules. Receipt of one or more inputs may be by one or more processors executing the one or more invoice quality sub-modules. Upon receipt of one or more inputs, one or more invoice quality algorithms may be executed. The invoice quality algorithms may include invoice matching, comparison, alert, and storage. An invoice matching algorithm may be executed upon receiving one or more transaction documents. The transaction document may be a copy of an invoice for inventory and/or services purchased by the workplace. The invoice matching algorithm may search for one or more order guides, inventory patterns, or both which coincide with the transaction document. Upon identifying the matching document, such as an order guide or inventory pattern, one or more comparison algorithms may be executed. The one or more comparison algorithms may compare the data within the transaction document, transaction record, transaction data entry, and/or the like to the retrieved matching document. The one or more comparison algorithms may automatically identify one or more discrepancies and/or the absence of between the transaction document and the retrieved matching document. If one or more discrepancies are identified, one or more alert algorithms may be initiated. One or more alert algorithms may transfer one or more identified discrepancies to one or more other modules. One or more other modules may include one or more checklist modules, logbook modules, action modules, the like, or a combination thereof. The one or more other modules may then generate an alert which is then displayed on a user interface as to the discrepancy. After executing one or more comparison algorithms, alert algorithms, or both, one or more storage algorithms may be automatically executed. Upon execution, the results of the comparison, identified discrepancies, updated trends in purchasing patterns, or a combination thereof may be transferred to one or more storage mediums, a backbone of the system, one or more other modules, or any combination thereof.

### Method for Managing Labor

The present teachings to relate a method for managing labor. The method may be for one or more workplaces. The method may be computer-implemented. The method may implement or be implemented by a labor module according to the teachings herein. The method may include one or more of the following steps: a) executing a sales sub-module and determining projected sales, b) executing a labor sub-module and determining projected staffing needs, and c) executing a scheduling sub-module and determining one or more recommended staffing actions.

The method may include first accessing a labor module. The labor module may reside within one or more storage mediums of the system. The labor module may be accessed by a backbone of the system. The labor module may be automatically accessed without user interaction. The labor module may be automatically accessed to initiate the method or may be initiated by a user. Initiation via a user may occur via a graphical user interface. The method may be automatically initiated during a predetermined time. The predetermined time may be overnight, during closed hours of a business, during open hours, or any combination thereof. Upon accessing the labor module, one or more sub-modules may be initiated. One or more sub-modules may include one or more sales sub-modules, labor sub-modules, scheduling sub-modules, the like, or a combination thereof.

The method may include executing a sales sub-module and determining projected sales. A sales sub-module may be automatically accessed, manually accessed, or both. A sales sub-module upon being accessed may be executed. Executing may include initiating one or more projected sales algorithms. Executing may include receiving one or more inputs. One or more inputs may be pushed and/or pulled from one or more external inputs, calendar inputs, workplace inputs, or any combination thereof. Receiving one or more inputs may include receiving data from one or more weather databases, events databases, promotions databases, calendar inputs, workplace inputs, the like, or a combination thereof. Receiving one or more inputs may include converting the input data to one or more input data entries. The one or more input data entries may be stored as one or more input records within one or more databases. The databases may include one or more sales model databases. The projected sales algorithms may automatically analyze the inputs, input data, input records, or any combination thereof. Upon analyzing, the projected sales algorithm may determine one or more sales trends; identify one or more weather patterns, events, and/or promotions positively or negatively impacting future sales; identify one or more sales trends associated with the time, day, week, month, year, season, holiday, or other calendar data; identify how trends between sales and workplace inputs; the like; or any combination thereof. The projected sales algorithm may automatically determine projected sales. The projected sales may be provided for a predetermined duration of time, forecasted out for a predetermined period of time, a user selected duration of time, forecasted out for a user selected predetermined period of time, the like, or any combination thereof. The projected sales may be transmitted to one or more graphical user interfaces, one or more storage mediums, a backbone, a labor sub-module, one or more other modules, the like, or any combination thereof.

The method may include executing a labor sub-module and determining projected staffing needs. A labor sub-module may be automatically accessed, manually accessed, or both. A labor sub-module upon being accessed may be executed. Executing may include initiating one or more labor algorithms. Executing may include receiving one or more inputs. One or more inputs may be pushed and/or pulled from one or more other modules, projected sales, staff profile inputs, the like, or a combination thereof. Receiving one or more inputs may include converting the input data to one or more input data entries. The one or more input data entries may be stored as one or more input records within one or more databases. The databases may include one or more labor databases. The one or more labor algorithms may automatically analyze the inputs, input data, input records, or any combination thereof. Upon analyzing, the one or more labor algorithms may identify what staffing is needed to support projected sales, what roles needed to be fulfilled by staff to support projected sales, which staff may be most adequate to fulfill the roles to support projected sales, the like, or a combination thereof. Upon analyzing, the one or more labor algorithms may automatically determine projected staffing needs. Projected staffing needs may be provided for a predetermined duration of time, forecasted out for a predetermined period of time, a user selected duration of time, forecasted out for a user selected period of time, the like, or any combination thereof. The projected staffing needs may be transmitted to one or more graphical user interfaces, one or more storage mediums, a backbone, a scheduling sub-module, one or more other modules, the like, or any combination thereof.

The method may include executing a scheduling sub-module and determining one or more recommended staffing actions. A scheduling sub-module may be automatically accessed, manually accessed, or both. A scheduling sub-module upon being accessed may be executed. Executing may include initiating one or more scheduling algorithms. Executing may include receiving one or more inputs. One or more inputs may be pushed and/or pulled from one or more other modules, projected staffing needs, one or more scheduling inputs, the like, or a combination thereof. Receiving one or more inputs may include converting the input data to one or more input data entries. The one or more input data entries may be stored as one or more input records within one or more databases. The databases may include one or more scheduling databases. The one or more scheduling algorithms may automatically analyze the inputs, input data, input records, or any combination thereof. Upon analyzing, the one or more labor scheduling algorithms may identify differences between one or more schedules and one or more projected staffing needs, recommend changes in scheduling of employees, recommend differences in roles of scheduled employees, recommend swapping of employees, adding or reducing hours and/or shifts of scheduled employees, modifying business hours, the like, or any combination thereof. Upon analyzing, the one or more labor algorithms may automatically determine one or more recommended staffing actions. Recommended staffing actions may be provided for a predetermined duration of time, forecasted out for a predetermined period of time, a user selected duration of time, forecasted out for a user selected period of time, the like, or any combination thereof. The projected recommended staffing actions may be transmitted to one or more graphical user interfaces, one or more storage mediums, a backbone, an action module, a checklist module, a logbook module, one or more other modules, the like, or any combination thereof.

The method may include initiating one or more staffing action alerts. One or more staffing action alerts may function to drive a user (e.g., manager) to take action upon one or more recommended staffing actions. One or more staffing action alerts may be automatically generated. One or more staffing action alerts may be generated once a scheduling sub-modules communications one or more recommended staffing actions to an action module, checklist module, logbook module, the like, or a combination thereof. One or more staffing action alerts may be generated on a user interface.

### Method for Managing and Identifying Presence of Illness

The present teachings relate to a method for identifying and managing the presence of one or more illnesses in an individual. The method may include one or more of the following steps: a) logging into an account associated with the individual one or more user interfaces; b) searching for a presence of a return date associated with the individual; c) comparing the return date to a current date and making an initial determination based on the comparison; d) presenting the individual with one or more questions via one or more user interfaces; e) receiving one or more answers from the individual to the one or more questions via the one or more user interfaces; f) receiving a bodily temperature reading of the individual from a temperature sensing device; g) identifying the presence and/or absence of the one or more illnesses in the individual; and h) informing the individual of the presence and/or the absence of the one or more illnesses via the one or more user interfaces.

The method may include opening an application. The application may be opened via one or more computing devices. By opening the application, one or more individuals may be able to access one or more features of the system, execute one or more modules, methods, instructions, and/or the like. The application may be accessible as a preloaded and stored application, a browser, the like, or any combination thereof. Upon opening the application, an individual may be prompted to log-in. Opening the application may be part of any method disclosed within the present teachings.

The method may include logging into an account associated with the individual one or more user interfaces. Logging into an account may allow for a user to access their or other’s account information stored within the system. Logging into the account may allow a user to access their information or others’ information within the application. An individual may log-in via a user interface in communication with the application. The user interface may display a log-in interface of the application. Logging into the account may include inputting one or more user credentials. User credentials may include a username, email, password, image, or any combination thereof. An image may include an individuals’ face, fingerprint, eye (e.g., retina), the like, or any combination thereof. An image may be inputted via one or more computing device’s sensors, such as optical sensors. An image may be compared to one or more previously stored images associated with the individual. An image may be useful for facial recognition, fingerprint identification, iris and/or retina recognitions, and/or the like. Logging into an account may be part of any method disclosed within the present teachings.

The method may include authenticating an individual. Authenticating may be automatically initiated upon logging in. Authenticating may compare one or more user credentials to a repository of registered users. The registered users may be stored within a database, such as a user database. If the user credentials match with one or more records associated with one or more registered users, the individual may be authenticated. Upon being authenticated, an individual may have access into the application. Access may be determined based on one or more privileges and roles associated with the individual. If an individual is found not to be a registered user, the method may include prompting the individual to request access. Via the user interface, the application may notify the individual of who to contact and by what means to request access into the application. The application may also provide a registered user request interface. The individual may then be prompted to enter their desired user credentials for approval by an administrator. Authenticating an individual may be part of any method disclosed within the present teachings.

The method may include searching for a presence of a return date associated with the individual. Searching for the presence of a return date may be referred to as searching for the presence of one or more flags. Upon an individual logging in and/or being authenticated, the method may include automatically searching for the presence of a return date. The return date may be a return date associated with the specific individual. The return date may have been previously established from previous inputs into the application and/or system. The return date may be associated with one or more records associated with the user. If a return date is found associated with the account of the individual, the return date may be compared with the current (e.g., present) date.

The method may include comparing the return date to a current date and making an initial determination based on the comparison. The return date may function to identify if the individual is safe to return to a designated environment based on previously identified symptoms, risks, and/or illness. If the return date is either on the same day or later than the current (e.g., present) date, the individual is considered not safe to return to the designated environment. If the individual is considered not safe to return, the method may include automatically displaying a return date notification. If the return date is prior to the current date, the individual is considered as screenable. Screenable may mean being presented with one or more questions, having one or more bodily functions taken, or both.

The method may include presenting the individual with one or more questions via one or more user interfaces. The one or more questions may be presented via a question interface. The question interface may be the graphical user interface presented to a user within the application. The one or more questions may function to identify if the individual has been exposed to one risk factors, is experiencing one or more symptoms of one or more illnesses, has an illness, or any combination thereof. The one or more questions and one or more correct and/or desired answers may be stored within the application. The method may include programming one or more questions into the application. The one or more questions may be provided by a governing authority, licensing authority, internal management, best practices, global health organizations, and/or the like. The one or more questions may identify if the individual has been exposed to one or more risk factors, is exhibiting one or more symptoms of an illness, or has an illness. The one or more questions may be stored within a questions database.

The method may include receiving one or more answers from the individual to the one or more questions via the one or more user interfaces. An individual may input one or more answers to the one or more questions via a user interface. The individual may choose from predetermined answers. The predetermined answers may be referred to an answer prompts. The individual may be presented with a desired answer and an undesired answer. The individual may have to pick among answers presented on the interface.

The method may include receiving a bodily temperature reading of the individual from a temperature sensing device. One or more illnesses are typically associated with a higher than normal body temperature, indicating a fever. The bodily temperature reading may be received via a temperature input, temperature interface, and/or both. A temperature interface may be the graphical user interface displayed in the application. A temperature interface may allow for a user to provide a temperature input, supplemental temperature input, or both. A temperature interface may allow for a user to manually input their temperature, receive a reading from a thermo sensing device, or both. If a user manually inputs their temperature into the temperature interface, the user may be prompted to upload an image of the thermo sensing device with the temperature. A baseline temperature may be stored within the application. The baseline temperature may be the maximum temperature acceptable before a user is deemed to be displaying a symptom of an illness. For example, a baseline temperature may be about 100.4° F. A temperature at the baseline or higher may indicate the presence of a fever.

The method may include identifying the presence and/or absence of the one or more illnesses in the individual. By an individual inputting a response to a question which is an undesired answer, exhibiting a fever above a baseline temperature, or both the method may determine the individual has been exposed to one or more risks, is exhibiting one or more symptoms, or both of one or more illnesses. The method may determine that the individual is considered at-risk and should not enter a designated environment. The method may perform this step after receiving one or more answers, a bodily temperature, or both and in any order.

The method may include informing the individual of the presence and/or the absence of the one or more illnesses via the one or more user interfaces. Base on the one or more answers to questions, bodily temperature, or both, the method may inform the individual of the presence and/or absence of one or more illnesses. The notification may be displayed within the application. The notification may be displayed as a certification interface, return notification, or both.

The method may include automatically generating a certification. If an individual is considered to not be at-risk, low risk, or both of carrying an illness, the individual is considered safe. If the individual is considered safe, the application may display a certification interface. A certification interface may be a graphical user interface displaying a certification. A certification may function as an indicator that the individual has not exhibited any symptoms, been exposed to any risks, and is considered safe to proceed to another on-site screening, enter the designated environment, or both. The certification may allow for the user to easily show others that he or she has been considered safe, answered the questions, provide a bodily temperature, and/or the like. The certification may be in the form of a code. The code may be a QR code, barcode, randomly generated identification number, the like, or any combination thereof.

The method may include establishing a return date. If an individual is determined to be at risk of carrying an illness, the individual may be considered unsafe. If the individual is considered unsafe, the application may display a return date notification. The return date notification may include an estimated date to return to work, be re-screened using the method, or both. The return date notification may also provide advice to the individual for self-care, seeking medical attention, avoiding the designated environment, avoiding contact with other individuals to minimize risk of transmission of an illness, the like, or any combination thereof. A return date may be established based on guidance from governmental authorities, licensing authorities, health organizations, medical experts, the like, or any combination thereof. A return date may be established for a period of time after first exhibiting systems, being exposed to a risk, a quantity of time after being free of symptoms, the like, or any combination thereof. For example, a return date may be established for 10 to 14 days after first exhibiting one or more symptoms. As another example, a return date may be established for 3-7 days after being free of all symptoms. Once a return date is established, it may be stored and associated with the individual’s account.

The method may include automatically updating and/or generating an analytics interface. The analytics interface may be a display on the graphical user interface of the application. The analytics interface may display analytics related to one or more illnesses, risks, and/or symptoms. The analytics interface may display one or more maps, graphs, charts, and the like. One or more maps may include one or more heat maps. One or more heat maps may provide a visual analysis of concentrations of one or more potential illnesses. Using the registered user data, designated environment data, or both, the method may include analyzing occurrences of symptoms and/or risks. A heat map may show where concentrations of the illness may be located. The concentration levels may be shown as little to no occurrence, modest occurrence, high occurrence, and even extremely high occurrence. The concentration levels may be designated by different colors, shades of colors, or both. The analytics data may be useful in allowing entities to determine if an illness is spreading, the seriousness of the illness, appropriate mitigation steps based on area, or any combination thereof. The analytics data may be automatically anonymized.

The methods disclosed herein may all be executed and/or cooperate together. For example, an illness detection module may communicate with a labor module, action module. An illness detection module may trigger a labor module and/or action module to recommend one or more staff actions. For example, upon an illness or likelihood of illness being detected, the illness detection module may communication to the labor module. The illness detection module may communicate to the labor module the name of the individual, the date of detection, the date of return, any other data collected or determined, and/or the like.

Any of the methods, processes, modules, algorithms, and/or the like disclosed herein may be executed by one or more processors of the system. The one or more processors may access instructions from one or more storage mediums. The one or more processors may automatically execute any of the steps of any of the methods disclosed herein. The method disclosed herein may be computer-implemented. Receipt of one input, whether manual or automatic, may trigger one or more processors to automatically execute one or more further steps.

### Machine Learning

The system and/or methods described herein may utilize machine learning. Machine learning may function to support one or more steps in any of the methods disclosed herein. Machine learning may function to support facial recognition, analytics, questions, temperature determination, trends, patterns, discrepancies, recommendations, projections, and/or the like. Machine learning may function to expedite processes of the method, increase accuracy of inputs and outputs, and/or the like.

The present disclosure may relate to a method of machine learning to determine one or more trends, patterns, text recognition, document format recognition, and the like. Machine learning may function to learn one or more trends and/or patterns in sales to provide real-time projected sales, projected staffing needs, and/or recommended staffing actions, inventory balances, inventory discrepancies and/or recommendations, illness detection, any other output of the system, the like, or any combination thereof. Machine learning may use historical sales, historical external inputs (e.g., weather, promotions, events), historical calendar input, and/or historical workplace data to learn sales trends and/or patterns. Machine learning may use historical sales, historical staffing, and historical staffing profiles to learn staffing trends. Machine learning may use historical staffing trends, historical sales, historical scheduling input to learn scheduling trends and staffing actions. Machine learning may use historical emails, order forms, order guides, and/or other inventory requests to learn historical trends in inventory ordering, learn different formats for ordering, learn what data to recognize to create ordering forms, create order form guides, and/or the like. Machine learning may use historical transaction documents to learn historical trends in transactions, learn different formats of transaction documents, learn what data to recognize to determine the identification of the transaction form, create transaction records, and/or the like.

Machine learning may be performed by one or more processors of a computing device. Machine learning may be automatically performed by one or more processors of a computing device part of or separate from the system. Machine learning may be performed upon being triggered by a user and then executed by one or more processors of a computing device.

The method of machine learning may include a neural network (e.g., “artificial neural network”). Neural networks are generally presented as systems of “neurons” which can compute values from inputs, and as a result of their adaptive nature, are capable of learning and/or recognizing patterns. The neural network may be a deep neural network (DNN). A neural network may function my linking a plurality of nodes. The plurality of nodes may be within one or more input layers, hidden layers, output layers, or a combination thereof. The one or more input layers may be associated with one or more inputs. The one or more output layers may be one or more projections, recommendations, discrepancies, differences, and/or the like. Each node may be responsible for a computation (e.g., execution of an algorithm). Exemplary neural networks, configurations, and training methods are discussed in “Deep Learning” by Ian Goodfellow, et al, Massachusetts Institute of Technology, 2016; incorporated herein by reference in its entirety.

Any method supported by machine learning may include a method of training. Training may allow for the machine learning method to learn how to automatically identify one or more trends, patterns, discrepancies, recommendations, and/or projections to provide one or more outputs for one or more inventory management methods, labor management methods, illness detection methods, the like, or any combination thereof. Training may include supervised learning, unsupervised learning, reinforcement learning, or any combination thereof. The more data that is collected and analyzed, the more accurate the outputs may be. The training method may be completed in a live mode, offline mode, or both. A live mode may collect input data provided from one or more input connections (e.g., external input, calendar input, workplace input) and/or users and simultaneously capture the associated output (e.g., sales). An offline mode may collect input data provided by one or more input connections and/or users and thereafter append the associated output.

Machine learning may cooperate with one or more sensing devices, thermosensing devices, optical sensors, and/or combination thereof. Machine learning may use one or more images to determine the identify of an individual, bodily temperature of an individual, or both. Machine learning may include face detection and identification.

The method may include face detection. Face detection may function to find one or more faces within one or more images uploaded by a user. Face detection may first identify a face within the image. Once identified, face detection may include facial analysis. Facial analysis may function to find one or more features of a face within the image. The features may include color, location, measurements, status, or a combination thereof of one or more facial features. After facial analysis, facial detection may include facial recognition. Based on the identified face, the facial features, or both, the individual in the image may be identified. The individual may have one or more images associated with their account as a registered user. Face detection may be able to identify the individual by comparing the image to the images of registered users and finding likeness and/or differences between the facial features. Face detection may be useful for the user logging into the application, avoiding the user logging in, or both. Face detection may cooperate with thermosensing devices. Face detection may cooperate with thermal imaging devices. For example, the thermal image captured to generate a bodily temperature may also be utilized to identify a user. This may be useful in identifying individuals as they have their temperatures taken by a thermal scanner and automatically saving their data, ensuring they have completed other requirements, and/or providing a certification.

### Illustrative Embodiments

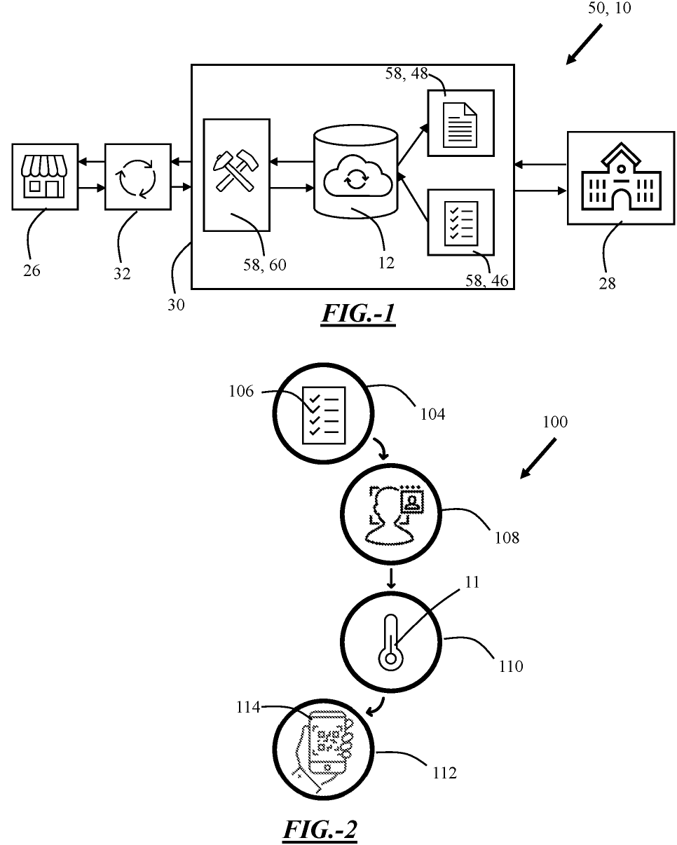

FIG. 1 illustrates a macro architecture 50 of the system 10. The system 10 includes a server 12. The server 12 has a plurality of modules 58 therein. Some of the modules 58 are accessible and executable by an application 32. Some of the modules 58 may be client modules 60. The application 32 may be accessible at or by those associated with a designated environment 26. The server 12 may be in communication with one or more compliance reporting modules 44 and regulations modules 46. The server 12 and some of the modules 58 may be accessible by one or more government systems 28. Other modules 58 may be stored on the server 12 that are not illustrated, and which are accessible by either the application 32 and/or government systems 28.

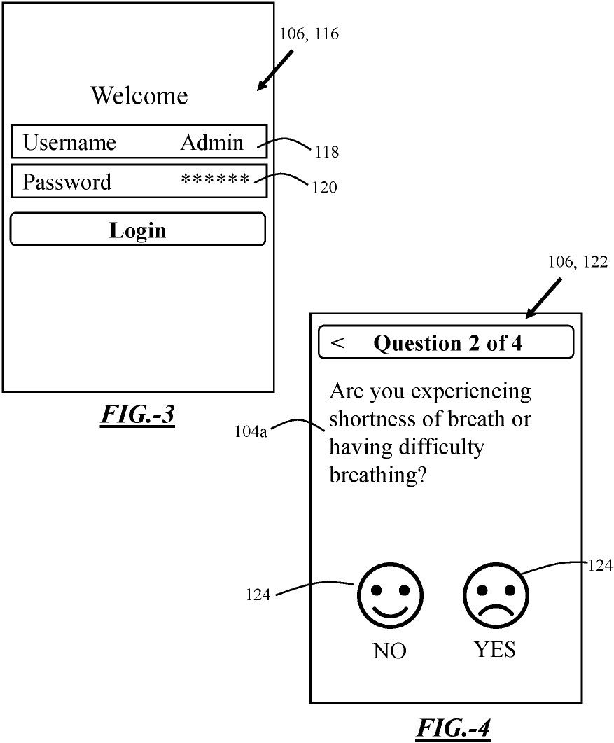

FIG. 2 illustrates a method 100 for identifying and managing illness in an individual 102 (Not shown). The method 100 includes presenting the individual 102 with a plurality of questions 104. The questions 104 are presented via a graphical user interface 106. The questions 104 may be presented on a personal computing device, such as a mobile phone of the individual. The questions 104 may be presented prior to the individual 102 arriving at a predetermined location, such as their place of employment or an event venue. The method 100 may allow for a user to logon or have data matched via facial recognition 108. Facial recognition 108 may be conducted using the personal computing device, a sensing device, and/or a computing device of the predetermined location. If the questions 104 are successfully passed, the individual 102 may be prompted for a temperature input 110. The temperature input 110 may be received by a sync with a temperature sensing device 111, such as a digital thermometer, thermal scanning unit, or the like. The temperature input 110 may be entered in manually. The temperature input 110 may even request a photo be uploaded with a photo of a thermometer used by the individual 102. Upon successfully completing the questions 104 and temperature input 110, a certification 112 may be generated. The certification 112 may be a code 114, such as a QR code.

FIG. 3 is a graphical user interface 106 displaying a log-in interface 116. The log-in interface 116 allows an individual 102 to log-in to their user account on the system 10. The log-in interface 116 prompts an individual for a username 118 and password 120. As an alternative, facial recognition 108, or other recognition security methods (e.g., fingerprint, retina) could be used to log-in.

FIG. 4 is a graphical user interface 106 displaying a question interface 120. The question interface 120 is displaying a single question 104a of the plurality of questions 104. The question interface 120 displays answer prompts 124. The answer prompts 124 are buttons which can be selected by the individual via the graphical user interface 106.

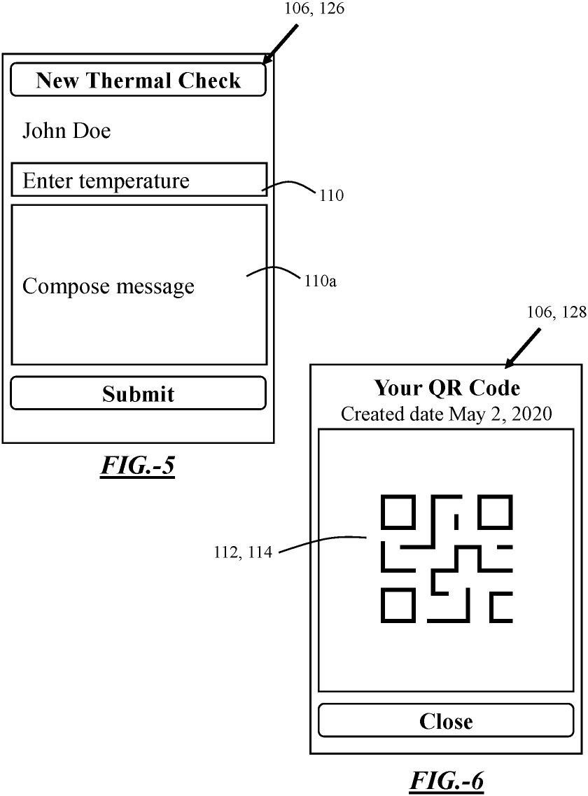

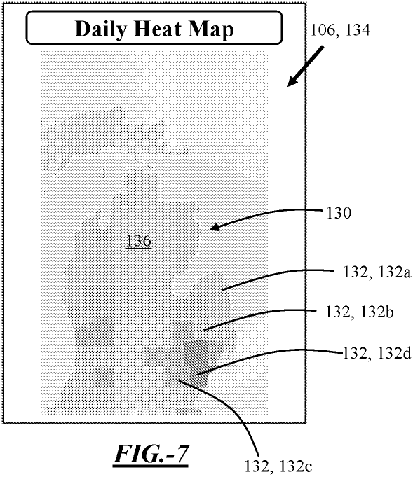

FIG. 5 is a graphical user interface 106 displaying a temperature interface 126. The temperature interface 126 includes a temperature input 110. The temperature input 110 may allow for manual entry or automatic entry of a body temperature of an individual 102 (not shown). The temperature interface 126 includes a supplemental temperature input 110a. The supplemental temperature input 110a may allow for a written message and/or image to be included. For example, the individual 102 may upload an image of their personal thermometer showing their temperature.

FIG. 6 is a graphical user interface 106 displaying a certification interface 128. Once an individual has successfully taken the plurality of questions 104 and entered in a passing temperature input 110, the certification interface 128 may be able to be displayed. The certification interface 128 shows a certification 112, such as code 114. The code 114 may be in the form of a QR Code.

FIG. 7 is a graphical user interface 106 displaying an analytics interface 134. The analytics interface 134 displays a heat map 130. The heat map 130 displays concentrations 132 of illness throughout a predesignated area 136. For example, the predesignated area 136 may be a state, such as Michigan. Concentrations 132 may include little to no occurrence of illness 132a, modest occurrence of illness 132b, high occurrences of illness 132c, and extremely high occurrences of illness 132d. The concentrations 132 may be determined based on location of individuals, workplaces, venues, and the like stored within the system 10.

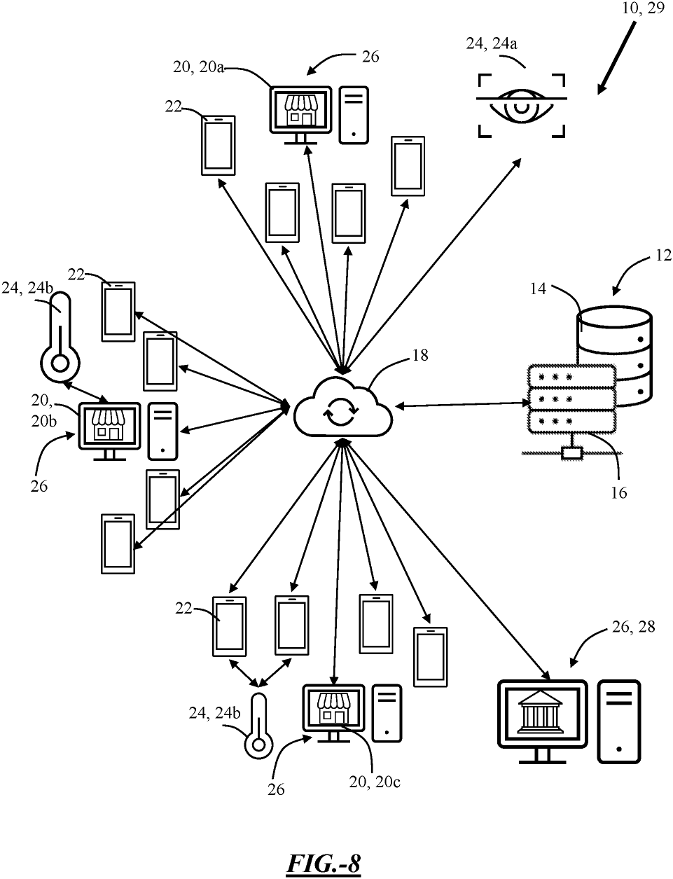

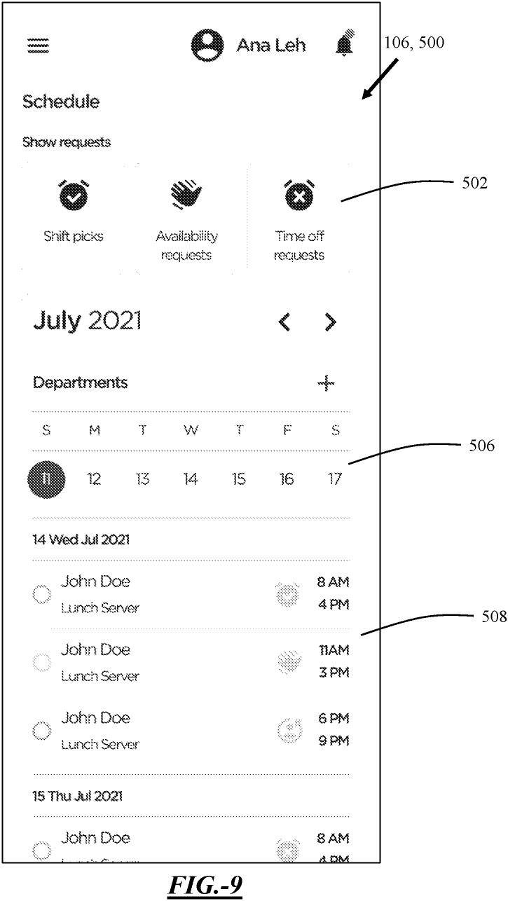

FIG. 8 illustrates a network 29 of the system 10. The system 10 includes one or more servers 12. The one or more servers 12 may include one or more storage devices 14 and processors 16. The one or more storage devices 14 may have one or more databases, executable instructions, or both stored therein. The one or more servers 12 are in communication with the Internet 18. Via the Internet 18, the one or more servers 12 are in communication with a plurality of computing devices 20. The computing devices 20 include on-site computer systems 20a and individual computing devices 22. The on-site computer systems 20a may include computing devices specific to a designated environment 26. Individual computing devices 22 may be located remote from or at the same site as the designated environment 26. Via the Internet 18, the individual computing devices 22 may be in communication with the on-site computer systems 20a. The system 10 includes one or more thermo sensing devices 24. The thermo sensing devices 24 may include thermal scanners 24a, individual thermometers 24b, or both. The thermo sensing devices 24 may be in direct communication with the Internet 18, an onsite computer system 20a, personal computing devices 22, or may even be analog devices. Via the Internet 18, the system may be in communication with or include one or more governmental systems 28.

FIG. 9 is a graphical user interface 106 displaying a management scheduling interface 500. The management scheduling interface 500 includes employee requests 502. The employee requests can include shift picks, availability requests, and/or time-offrequests. The management scheduling interface 500 includes a calendar view 506. The management scheduling interface 500 includes a scheduling summary 508. The management scheduling interface 500 may be part of a labor module 39.

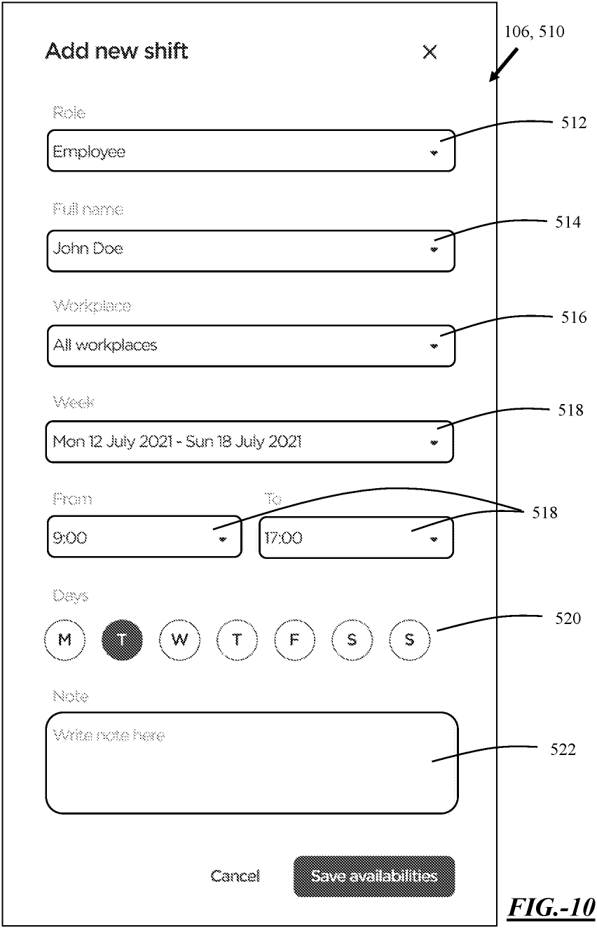

FIG. 10 is a graphical user interface 106 displaying a management shift scheduling interface 510. The shift scheduling interface 510 may allow for an individual to schedule shifts of employees at a workplace. The shift scheduling interface 510 provides for role selection 512. Role selection 512 may allow for an individual to pick a specific employment role which is being scheduled. The shift scheduling interface 510 provides for employee selection 514. Employee selection 514 may allow for selecting a specific employee. The shift scheduling interface 510 provides for workplace selection 516. Role selection 516 may allow for selecting of a specific workplace if more than workplace may be available (e.g., a manager or owner manages multiple restaurants or offices). The shift scheduling interface 510 provides for a timeframe selection 518. The timeframe selection may allow for the selection of a specific timeframe. The timeframe may be in varying units (e.g., weekly, monthly). The shift scheduling interface 510 provides for a time selection 520. A time selection may allow for the selection of a start time and an end time for an employee’s shift. The shift schedule interface 510 provides for a day selection 520. The day selection 520 allows for selecting one or more days for scheduling an employee. The shift scheduling interface 510 provides for a note entry 522. The shift scheduling interface 510 may be part of a labor module 39.

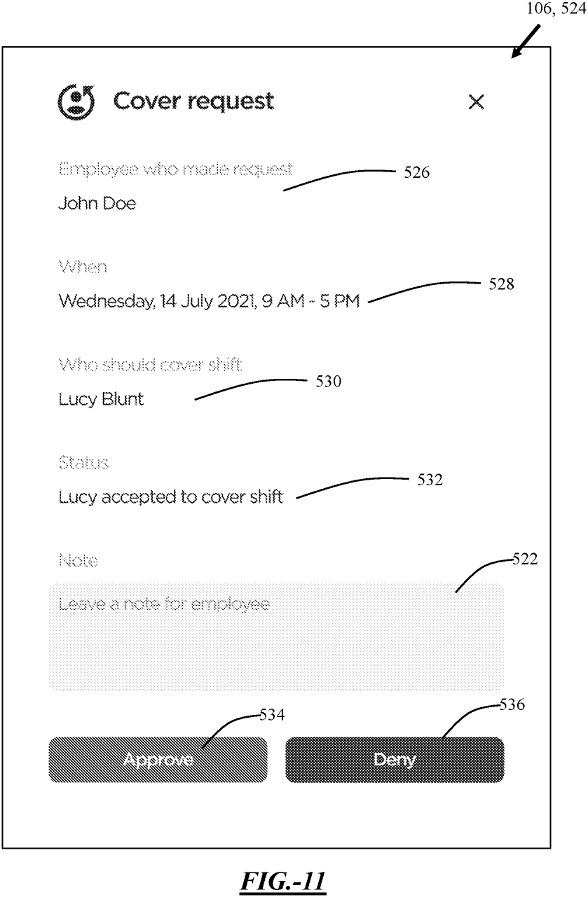

FIG. 11 illustrates a graphical user interface 106 displaying a cover request interface 524. The cover request interface 526 displays on employee 526, shift 528, covering employee 530, and a covering employee status 532. The cover request interface 524 allows for saving a note entry 522 which can be read by the employee 526 and/or covering employee 530. The cover request interface 524 may allow for a manager to approve 534 or reject 536 the covering employee 530 working the shift of an employee 526 during the indicated shift 528. The cover request interface 524 may be part of a labor module 39.

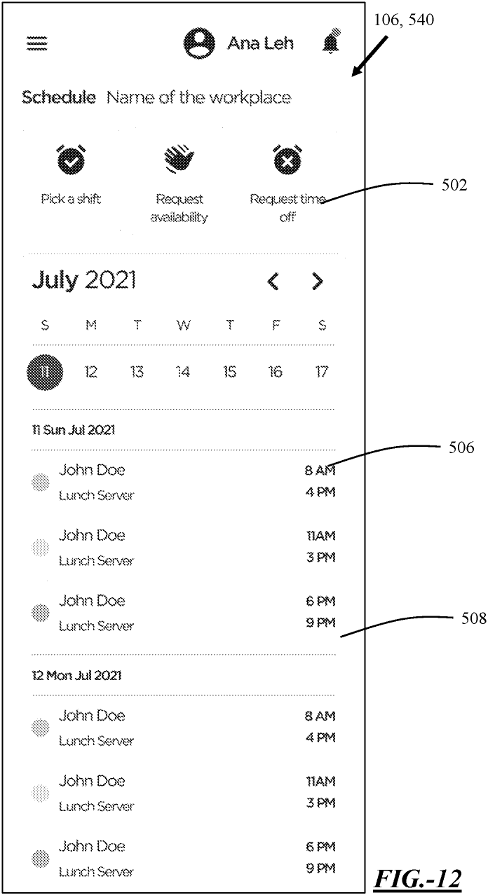

FIG. 12 is a graphical user interface 106 displaying an employee scheduling interface 540. The management scheduling interface 540 includes employee requests 502. The employee requests can include shift picks, availability requests, and/or time-off requests. These employee requests 502 are the submissions that may then viewed and approved from the management scheduling interface 500. The employee scheduling interface 500 includes a calendar view 506. The employee scheduling interface 500 includes a scheduling summary 508. The employee scheduling interface 540 may be quite similar to the management scheduling interface 500 but may allow for viewing only the employee’s schedule or also colleague’s schedules and submitting the employee’s own requests as opposed to being able to view everyone’s schedules and approving employee requests. The employee scheduling interface 540 may be part of a labor module 39.

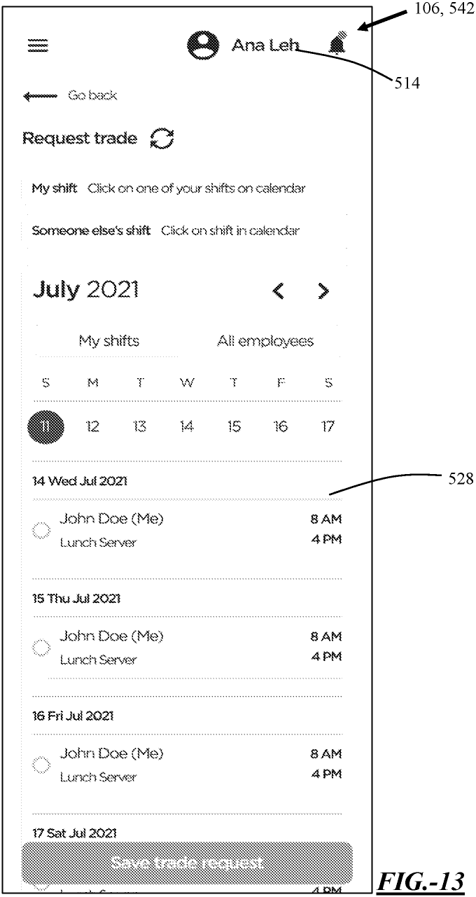

FIG. 13 illustrates a graphical user interface 106 displaying a shift trade interface 542. The shift trade interface 542 is specific to an employee 514. The employee 514 is able to select a shift 528. The shift 528 may be the shift an employee 514 wants to trade with a covering employee 530. After selecting the shift 514, the employee is able to then see shifts for which a covering employee 530 may be scheduled (not shown). The employee 514 may then select which shift of a covering employee 530 he/she would like to trade with their selected shift 528. Once the covering employee 530 and the traded shift is selected, the employee 514 may submit. Upon submission, this swap can then be viewed on the cover request interface 524 (such as shown in FIG. 11). The shift trade interface 542 may be part of a labor module 39.

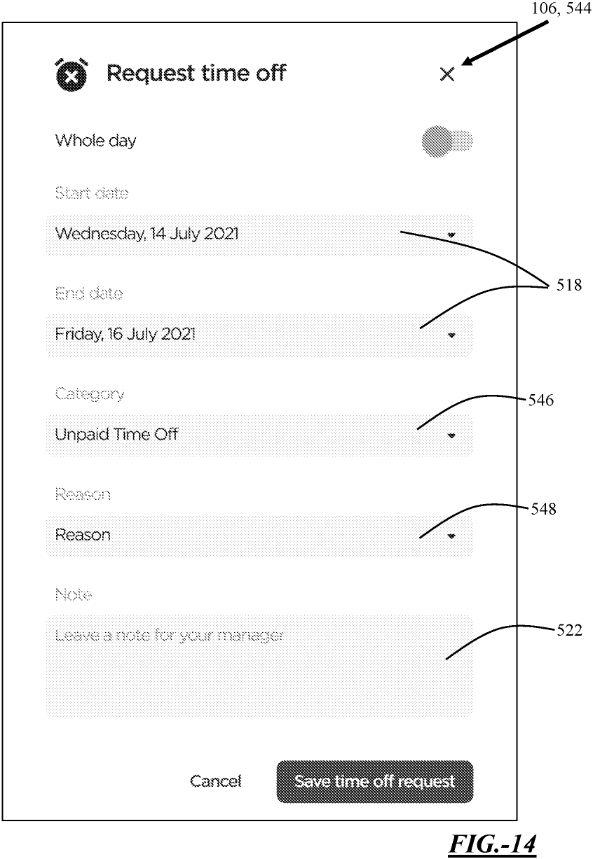

FIG. 14 illustrates a graphical user interface 106 for displaying a time off request interface 544. An employee 514 is able to submit a request for taking time off such that they are not available to be scheduled and/or are removed from a schedule (e.g., no shift trading). The employee can select a timeframe selection 518. The time frame selection 518 may include a start date and an end date. The employee 514 is able to select a time-off type 546. The time-off type 546 may include unpaid time off, sick leave, paid time off, and the like. The employee 514 may be able to make a reason selection 548 as to why the time-off is being requested. A reason selection 548 may include vacation, medical appointment, child care, and the like. The time off request interface 544 further includes a note entry 522. The employee 514, if desired, can leave a customized message for the manager or other individual who approves the time-off in the note entry 522 section. The time off request interface 544 may be part of a labor module 39.

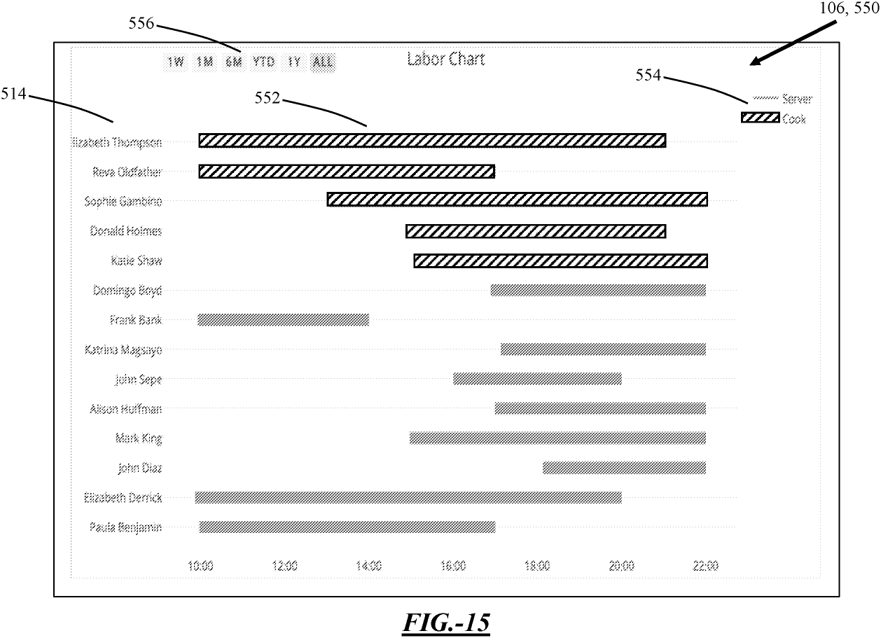

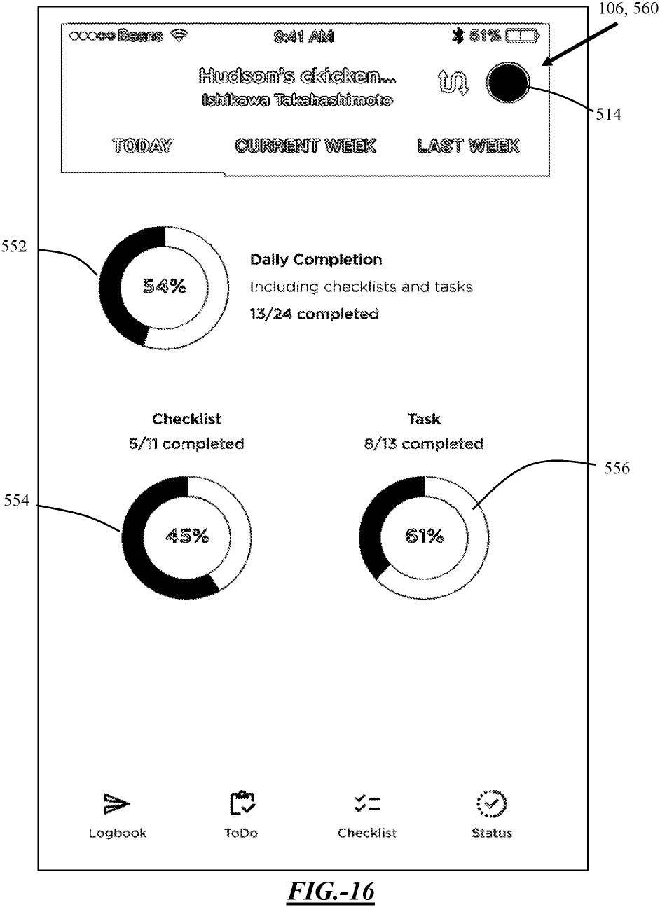

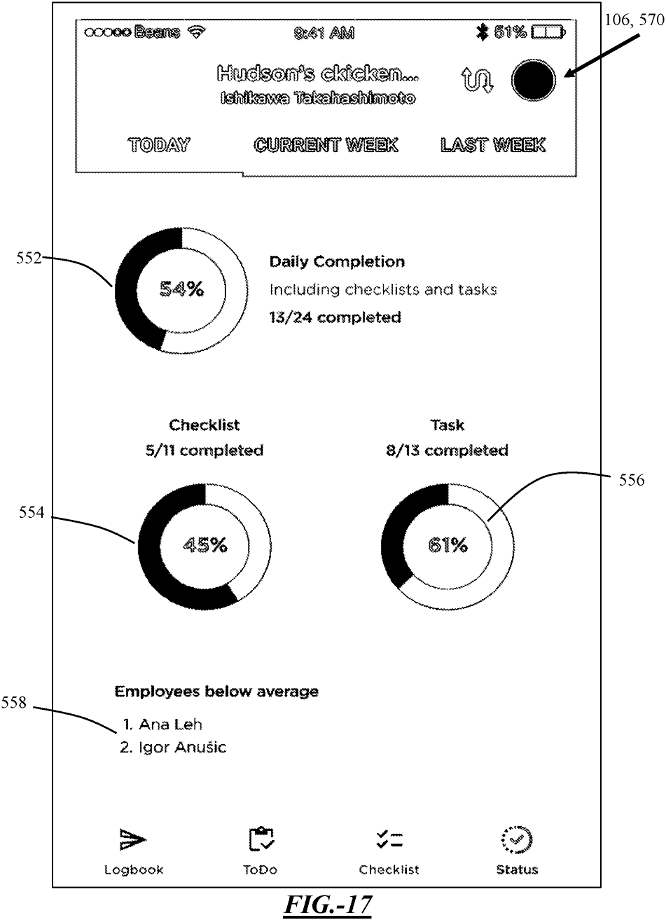

FIG. 15 illustrates a graphical user interface 106 displaying a labor trend interface 550. The labor trend interface 550 displays a number of employees 514. The labor trend interface 550 displays the positions 554 of the employees 513. The labor trend interface 550 displays the trending working times 552 of the employees 514. The trending working times 552 can be selected from varying periods 556 (e.g., weekly, monthly, yearly, etc.). The trending working times 552 may identify general gaps in coverage, typical working trends of employees 514, trends of over or under staffing, and the like.

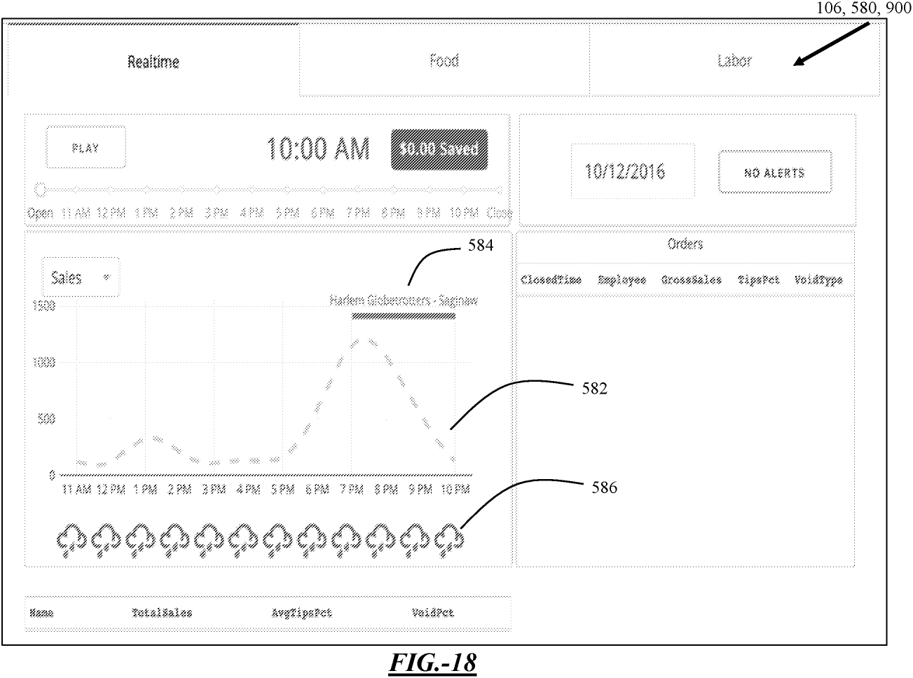

FIG. 16 illustrates a graphical user interface 106 displaying an individual work completion interface 560. The individual work completion interface 560 is specific to an employee 514. The individual work completion interface 560 displays an overall completion status 552. The individual work completion interface 560 also displays a checklist completion status 554 and task completion status 556. The checklist completion status 554 may be derived from the checklist items assigned to the employee 514 from a checklist module (not shown). The task completion status 556 may be derived from the action items assigned to the employee 514 from an action module (not shown).

FIG. 17 illustrates a graphical user interface 106 displaying an employee work completion interface 570. The employee work completion interface 570 is inclusive of all employees of a manager and may aggregate and/or average the work completed across the manager’s workforce. The employee work completion interface 570 displays an overall completion status 552. The employee work completion interface 570 also displays a checklist completion status 554 and task completion status 556. The checklist completion status 554 may be derived from the checklist items assigned to all employees 514 via a checklist module (not shown). The task completion status 556 may be derived from the action items assigned to all employees 514 from an action module (not shown). The employee work completion interface 570 also displays below average status 558. The below average status 558 may display employees which are below the average checklist completion status 554 and task completion status 556.

FIG. 18 illustrates a graphical user interface 106 displaying a sales impact interface 580 of a dashboard 900. The sales impact interface 580 consolidates sales 582, nearby events 584, and weather 568 into one view. The sales impact interface 580 allows for a user to determine if nearby events 584 and/or weather may be positively or negatively impacting sales 582. The sales impact interface 580 may utilize the external inputs 600, calendar inputs 608, restaurant inputs 612 to gather the displayed data.

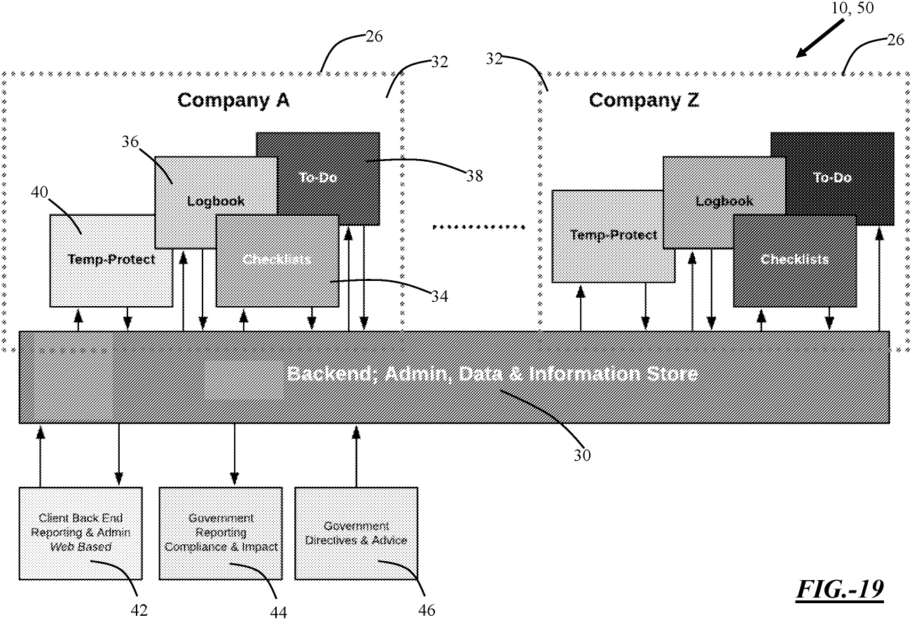

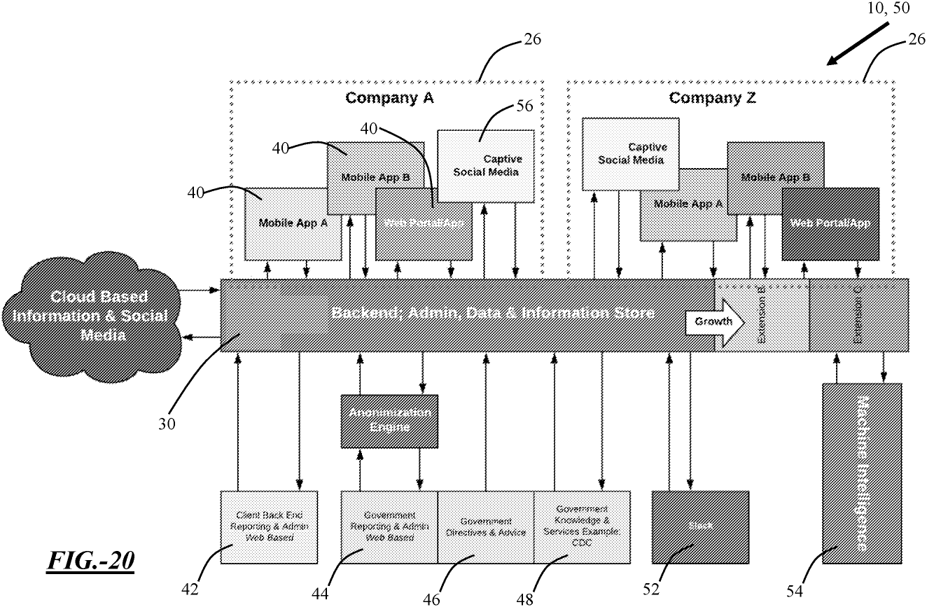

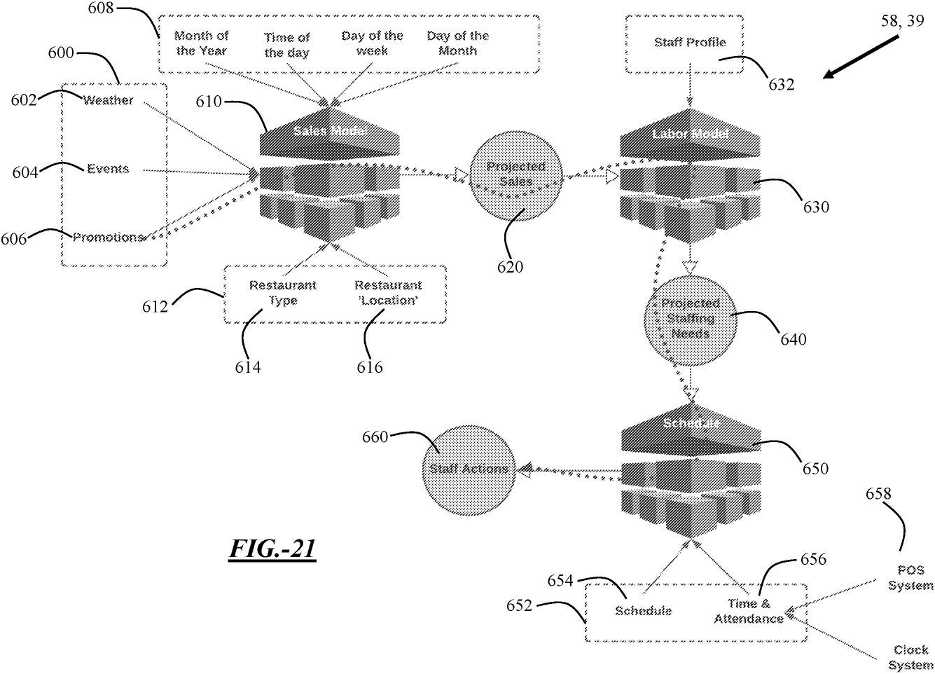

Both FIGS. 19 and 20 illustrate an architecture 50 of the system 10. The system 10 includes a backbone 30. The backbone 30 can include one or more servers 12 (not shown). The backbone 30 allows for the system to be in communication with designated environments 26. The backbone 30 allows for each designated environment 26 to access the application 32. The application 32 includes one or more checklist modules 34. The checklist module 34 can include a plurality of questions 104. The application 32 includes one or more logbook modules 36. The logbooks 36 may allow for all information recorded to be logged, accessed, and even audited. The application 32 includes an action item module 38. The action module 38 may allow for action items to be completed by employees to be logged, access, and completed. The application 32 includes an illness detection module 40. The illness detection module 40 aids in detecting the likelihood of an individual which is an employee and/or guest of a designated environment 26. Together with the checklist module 34, logbook module 36, and action module 38, not only can the probably of illness be detected but also managed and/or the workplace also managed. The backbone 30 is able to transmit communication gathered from any of the modules to administrators, a governmental system 28 (not shown), and the like. Such communication may be through a client reporting module 42. A client reporting module 42 may allow for designated environments 26 to analyze data collected via their application 32 and even data of other designated environments 26. A compliance reporting module 44 may allow for governmental systems 28 to review data collected by designated environments 26 via their applications 32. For example, governmental systems 28 may be licensing offices reviewing for compliance with regulations in place and determining impact of those regulations. The system 10 may include a regulations module 46. The regulations module 46 may allow for one or more governmental systems 28 to input regulations into the system 10 and be communication to one or more designated environments 26. The regulations module 46 may communicate with the designated environments 26 via the backbone 30. FIG. 9 illustrates that in addition to the regulations module 46, the backbone 30 may also be in communication with an authority knowledge module 48.

As illustrated in FIG. 20, the system 10 may include or be in communication with a communication platform 52. Based on the data collected from each of the designated environments 26 and individuals 102, machine intelligence 54 may be integrated into the system 10.

As further illustrated in FIG. 20, the system 10 may include one or more social media modules 56. The social media modules 56 may be part of the application 32.

FIG. 21 illustrates an architecture of a labor module 39. The labor module 39 may be another module 58 of a system 50. The labor module 39 receives one or more external inputs 600. These external inputs 600 are received by a sales sub-module 610. The external inputs 600 may be communications and/or a connection with one or more weather databases 602, events databases 604, and/or promotions databases 606. The one or more weather databases 602 may provide insight into weather 586 (for example, such as shown in FIG. 17). The one or more events databases 604 may provide insight into nearby events 584 (for example, such as shown in FIG. 17). The one or more promotions databases 606 may provide insight into certain promotional events being coordinated by one or more coordinating organizations. The labor module 39 receives calendar inputs 608. The calendar inputs 608 may be received by the sales sub-module 610. The calendar inputs 608 may provide a month of the year, day of the month, day of the week, and even time of the day. The labor module 39 may also receive restaurant inputs 612. Restaurant inputs 612 may include a restaurant type 614 and a restaurant location 616. Restaurant type 614 may include categories of restaurants (e.g., Mexican, Chinese, Italian, Seafood, Breakfast, Dinner, Take-out, Fine Dining, Sports Bar, etc.). Restaurant location 616 may identify the location of the restaurant such as by address, zone (e.g., downtown, midtown, etc.), and/or the like. The restaurant inputs 612 may also be received by the sales sub-module 610. Based on the external inputs 600, the calendar inputs 608, and the restaurant inputs 612, the sales sub-module 610 provides for projected sales 620. The projected sales 620 may be broken down by any of the calendar inputs 608. The projected sales may then be received by a labor sub-module 630. The labor module 39 also receives one or more staff profile inputs 632. The staff profile inputs 632 may include profiles of any and all staff associated with one or more workplaces. The profiles may be specific to each individual employee. Using the projected sales 620 and the staff profile inputs 632, the labor sub-module 640 may determine projected staffing needs 640. The projected staffing needs 640 may determine which staff members may be needed and on what days to support the projected sales. The labor module 39 also includes a scheduling sub-module 650. The scheduling sub-module 650 may receive the projected staffing needs 640. The labor module 39 also receives scheduling input 652. Scheduling input 652 may include one or more schedule inputs 654 and attendance inputs 656. Attendance inputs 656 may be received from one or more external systems 658, such as a point-of-sale system or a clock system. The scheduling input 652 may also be received by the scheduling sub-module 650. The scheduling sub-module 650 using the projected staffing needs 640 and the scheduling input 652 may then be able to prepare suggested staffing actions 660. Suggestion staffing actions 660 may include comparing the scheduling input 652 to the projected staffing needs 640 and providing recommendations to better suit what is needed to meet the demands of the projected sales 620.

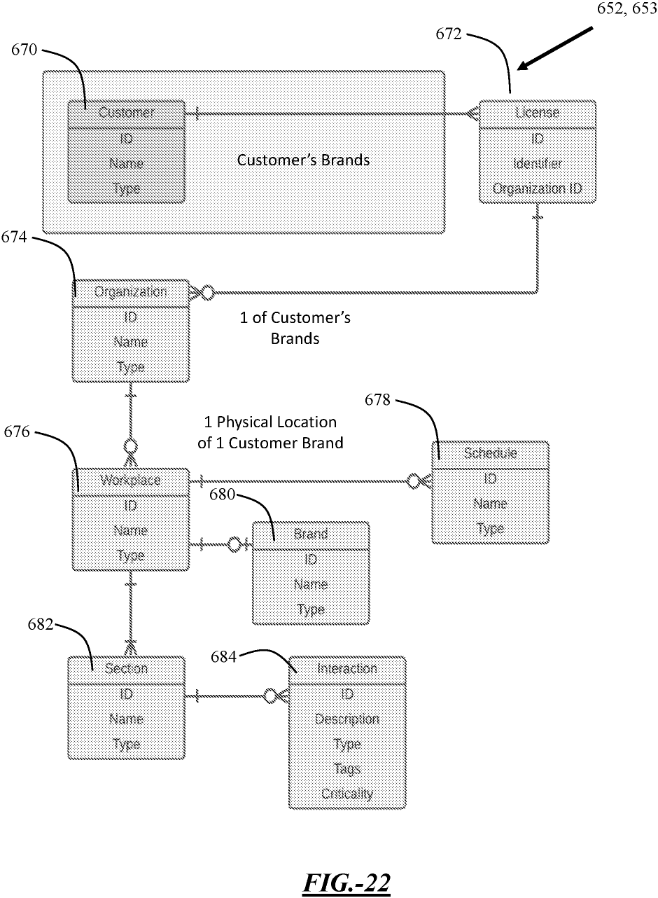

FIG. 22 illustrates a scheduling input 652. The scheduling input 652 may be associated with a labor module 39, such as illustrated in FIG. 22. The scheduling input 652 may transmit all or only a portion of its records or data over to the labor module 39. For example, the scheduling input 652 provided to a labor module may be a one or more schedule records 678. The scheduling input 652 may be in the form of an overall scheduling database 653. The scheduling database 653 may have one or more customer records 670. Each customer record 670 may be associated with an identification key (“ID”), a name of the customer (“Name”) and/or a type of customer (“Type”). A type of customer may refer to the type of business the customer may be (e.g., restaurant, bank, insurance agency, legal firm, small manufacturing company, etc.). Each customer record 670 may be associated with one or more license records 672. Each license record 672 may be associated with a license. A license may permit an organization to access the scheduling input 652, the overall labor module 39, the application 32, or even the overall system 10. Each license record 672 may be associated with a license itself, an identification key (“ID”), an identifier, and an organization ID. The customer associated with a customer record 670 may be associated with one or more organizations. Each organization may be associated with an organization record 674. An organization record 674 may be associated with a license record 672. An organization ID may tie a specific license record 672 to a specific organization record 674. An organization record 674 may include an organization ID (“ID”), a name, and a type. A name may be a name of the organization itself. Each organization record 674 may be associated with one or more workplace records 676. One or more workplace records 676 may include one or more workplaces, workplace IDs (“ID”), names, and/or types. A workplace may refer to a physical workplace (e.g., physical location of a workplace). Each workplace record 676 may be associated with one or more schedule records 678, a brand record 680, and one or more section records 682. Each schedule record 678 may be associated with a schedule, schedule ID, schedule name, and schedule type. Each brand record 680 may be associated with a brand, brand ID, brand name, and brand type. Each section record 682 may be associated with a section, section ID, name, and section type. Each section record 682 may be associated with one or more interaction records 684. Each interaction record 684 may be associated with an interaction, interaction ID, interaction description, interaction type, interaction tags, and interaction criticality. The IDs (e.g., identification key, identification) across each record in the scheduling database 653 may be what associates one record to another record within the scheduling database 653.

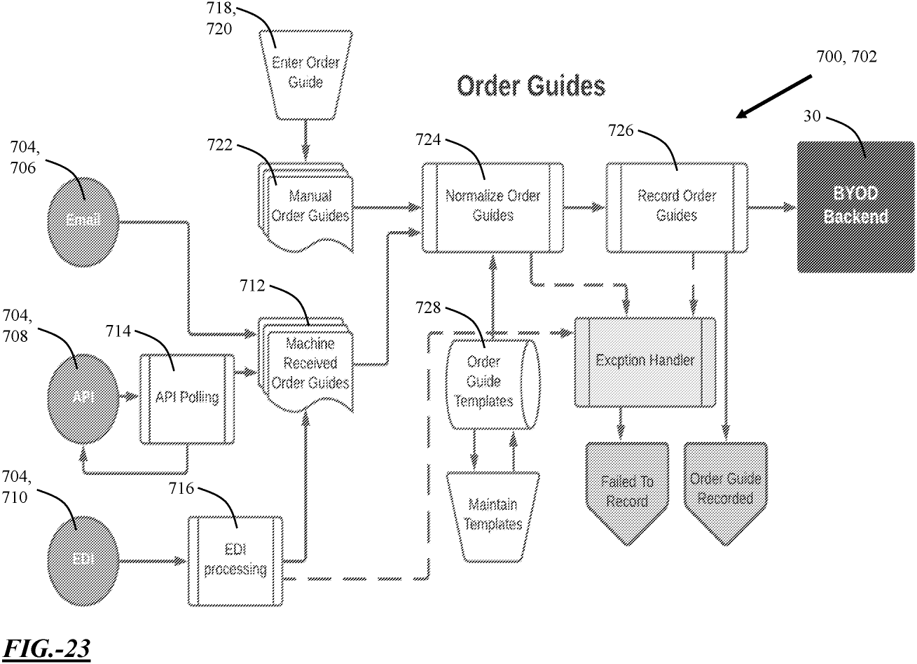

FIG. 23 illustrates a portion of an inventory module 700. The portion may be an order guide sub-module 702. The order guide sub-module 702 may provide for templates and guides for ordering inventory for goods, service requests, and the like. One or more order guides may be created beginning with one or more automatic information inputs 704. The automatic information inputs 704 may include information from email information 706, API information 708, and/or electronic data interchange (EDI) information 710. The automatic information inputs 704 may include information specific to inventory orders and/or deliveries. Inventory information may include vendors, goods, pricing, quantity, and the like. Email information 706 may be recognized as a machine received order guide 712. API information 708 may be evaluated for applicable inventory and guide data via API polling 714. EDI information 718 may be evaluated for applicable inventory and guide data via EDI processing 716. API information 708 and EDI information 710 may be organized as a machine received order guide 712. As an alternative or in addition to automatic information inputs 704, one or more order guides may be created beginning with one or more manual information inputs 718. The one or more manual information inputs 718 may include one or more user-generated order guides 720. A user-generated order guide 720 may be entered via a form and/or template accessible via a web portal or submittable via the Internet. The one or more manual information inputs 718 may be recognized as one or more manually received order guides 722. The one or more manually received order guides 722 and machine received order guides 712 may be normalized 724. Normalized may include adjusting scales of inventory from the inputs 704 and 718 to a common scale, determining suitable averages, and/or placing inventory values into predetermined order guide templates. Normalizing may include pulling in order guide templates 728. After normalizing, the order guides may be recorded 726 and then delivered to a backbone 30.

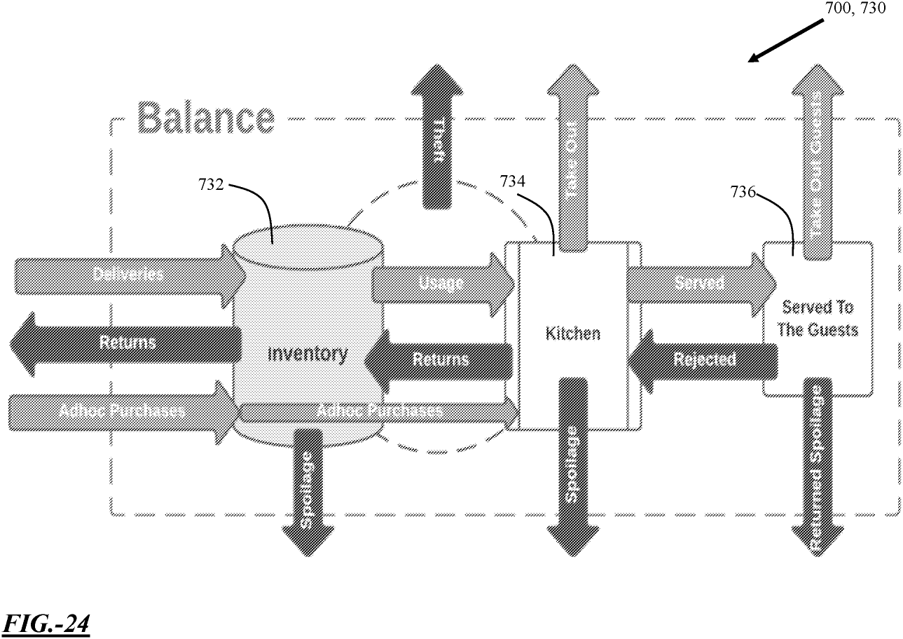

FIG. 24 illustrates a portion of an inventory module 700. The portion may be an inventory balance sub-module 730. The inventory sub-module 730 may determine a current balance of inventory 732. The current balance of inventory 732 is determined by the incoming deliveries, outgoing returns, and ad hoc purchases. The inventory 732, or portions thereof, may be transferred to kitchen inventory 734. Kitchen inventory 723 includes the usage of inventory, excludes returns back to inventory, includes ad hoc purchases, and excludes inventory lost to theft. Kitchen inventory 723 is then consumed by take-out, spoilage, or transferring to being served to guests 736. Kitchen inventory 734 served to guests 736 may return to the kitchen by being rejected by the guests. Inventory served to guests may be consumed on-site, spoilage, or taken as take-out by the guests. By knowing the inventory 732, kitchen inventory 734, and what is being served to guests 736 an overall picture of inventory may be understood.

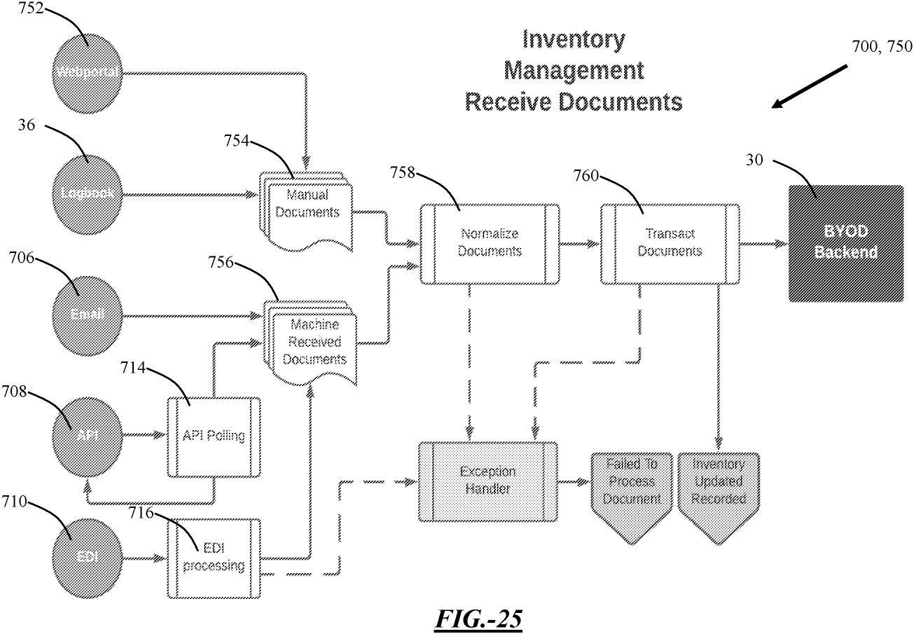

FIG. 25 illustrates a portion of an inventory module 700. The portion may be an inventory transaction sub-module 750. The inventory transaction sub-module 750 may receive transaction inputs from a web portal 752, logbook module 36, email information 706, API information 708, and/or EDI information 710. The API information 708 may be evaluated for relevant information via API polling 714. The EDI information may be evaluated for relevant information via EDI processing 716. Transaction inputs from a web portal 752 and a logbook 36 may be considered manually received documents 754. Transaction inputs from email information 706, API information 708, and/or EDI information 710 may be considered machine received documents 756. The manually received documents 754 and machine received documents 756 may be normalized 758. After normalizing, the transaction information may be converted into transaction documents 760 in a pre-templated format and transmitted into the backbone 30.

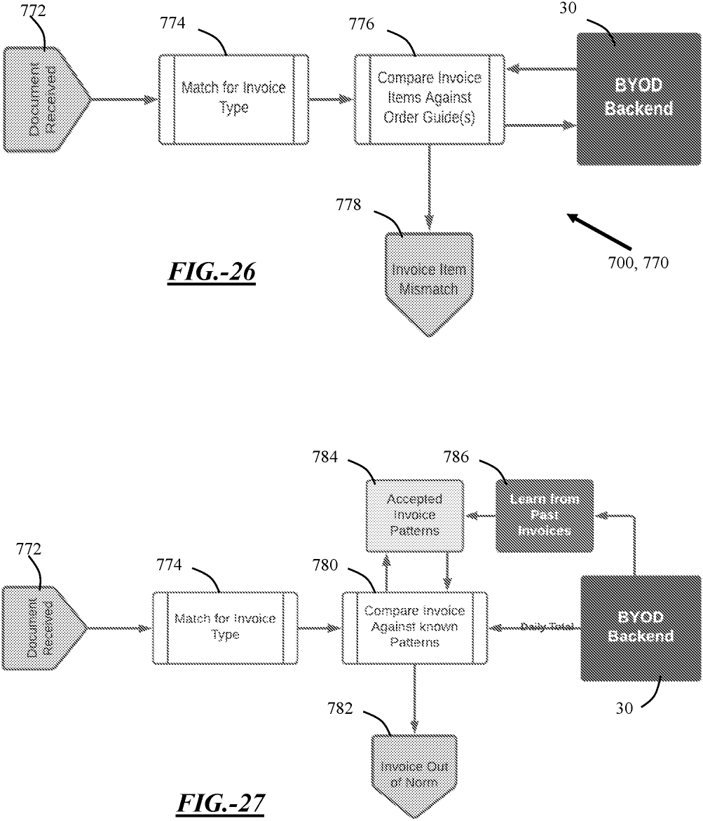

FIG. 26 illustrates a portion of an inventory module 700. The portion may be an invoice quality sub-module 770. The invoice quality sub-module 770 receives electronic versions of invoices 772. The received invoice(s) 774 is/are automatically evaluated to determine the type of invoice 774. Type may refer to the vendor, the goods or services, the order guide(s) associated with the invoice(s), and the like. Corresponding order guide(s) are received from the backbone 30. The invoice is then automatically compared against the corresponding order guide 776. Upon comparison, any discrepancies between the invoice and corresponding order guide are automatically identified 778. The comparison and the invoice(s) are then delivered to the backbone 30. The comparison and invoice(s) may be delivered to one or more inventory databases for storage via the backbone 30.

FIG. 27 illustrates a portion of an inventory module 700. The portion may be an invoice quality sub-module 770. The invoice quality sub-module 770 receives electronic versions of invoices 772. The received invoice(s) 774 is/are automatically evaluated to determine the type of invoice 774. Type may refer to the vendor, the goods or services, the order guide(s) associated with the invoice(s), and the like. Previously known invoice patterns corresponding to the invoice and invoice type are retrieved from a backbone 30. Upon retrieval of the corresponding invoice pattern(s), the invoice is then automatically compared against the corresponding invoice pattern(s) 780. If the invoice is different from the corresponding invoice pattern, the discrepancy is automatically identified 782. If the invoice is within an acceptable deviation of the invoice pattern, the invoice is accepted 784 without a discrepancy being identified 782. As invoices are received by the invoice quality sub-module 770, invoice patterns are learned and updated 786. Invoice patterns are learned and updated 786 such as through machine learning. The invoices and invoice pattern are transmitted to the backend 30. The comparison, invoice(s), and patterns may be delivered to one or more inventory databases for storage via the backbone 30.

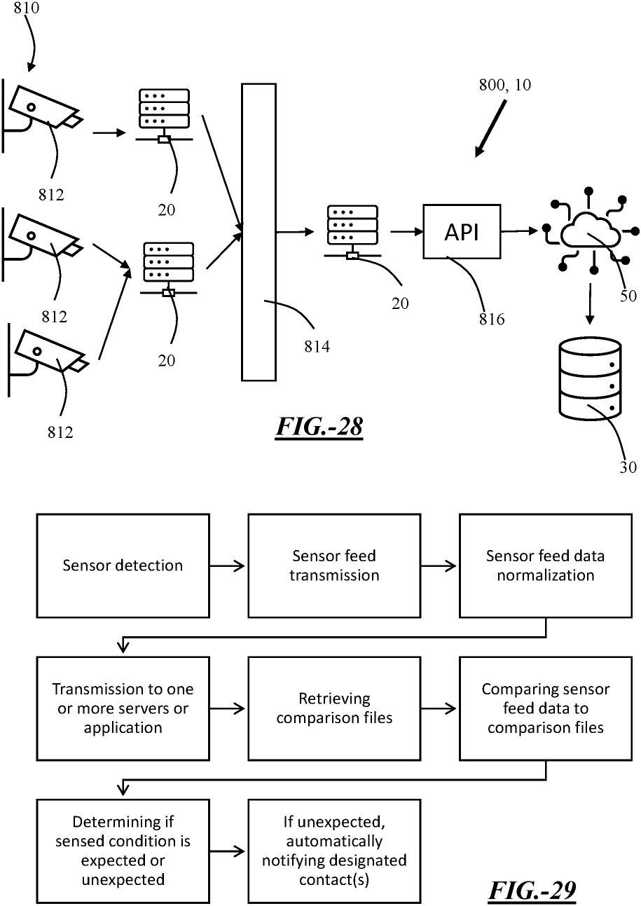

FIG. 28 illustrates a visual monitoring configuration 800 of the system 10. The visual monitoring configuration 800 includes a sensing feed 810. The sensing feed 810 is comprised of one or more sensors 812. The one or more sensors 812 can include video cameras, photo cameras, microphones, motion sensors, the like, or any combination thereof. One or more computing devices 20 are monitor and receive the input from the sensing feed 810. The one or more computing devise 20 normalize the sensing feed 810 before transmitting to an event bus 814. Normalizing may include digestible data which can be analyzed by one or more processors (e.g., breaking images down into frames, points, etc.). The data received by the event bus 814 may then be transferred to one or more other computing devices 20. The data from the computing devices 20 may then be transmitted to an application programming interface 816. From the application programming interface 816, the data may be transmitted to the application 30 and then to a database associated with the backbone 30.

FIG. 29 illustrates a method of conducting visual monitoring 850 with the system 10. The method 850 may commence with one or more sensing devices 812 (such as shown in FIG. 28) sensing, capturing, and/or continuously streaming one or more target objects. The one or more sensing devices 812 may transmit a sensor feed. The sensor feed may be transmitted to one or more computing devices 20. The one or more computing devices may normalize the data incoming from the sensor feed. The normalized data may be transmitted toward one or more computing devices 20, an event bus 814, and/or an application programming interface 816 (such as shown in FIG. 28). The data may then be transmitted to the application 50 and/or to one or more databases associated with a backbone 30 of the system 10 for storage. Any of the computing devices 20 part of the system may retrieve one or more comparison files. The one or more comparison files may be retrieved via a backbone 30 of the system 10. The one or more comparison files may include any data associated with any module 58 of the system. For example, comparison files may be retrieved from a labor module 39, one or more schedule inputs 654, one or more inventory modules 700, one or more external inputs 600, one or more calendar inputs 608, one or more staff profiles 632, one or more attendance inputs 656, the like, or any combination thereof.

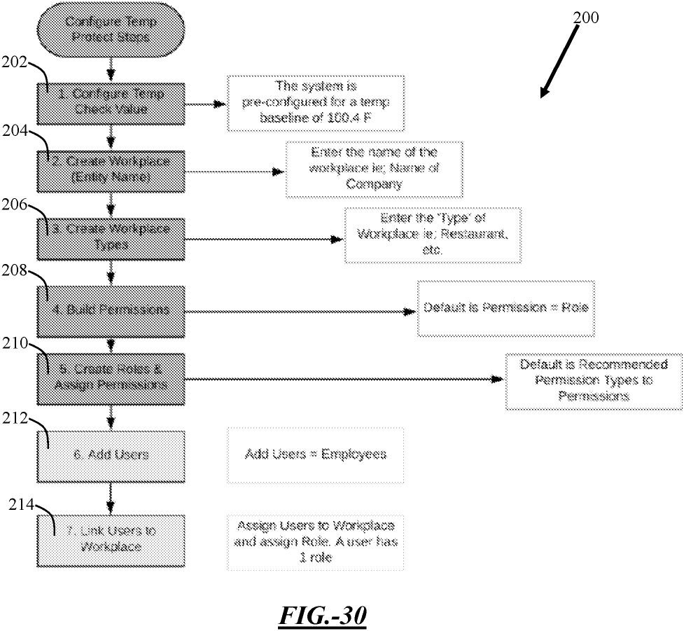

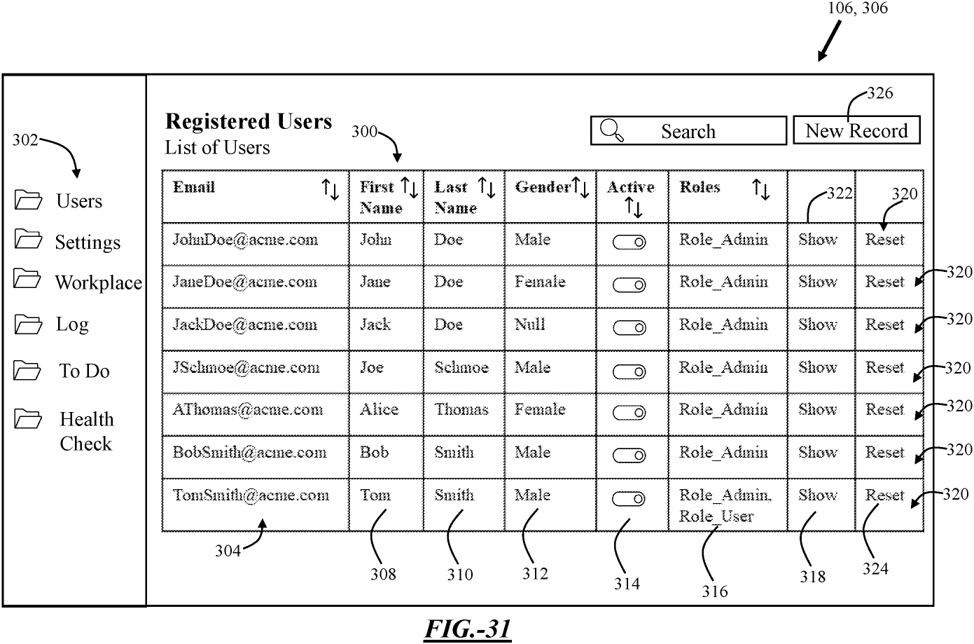

FIG. 30 illustrates a method 200 for configuring a system 100 and method 100 for identifying and managing illness. The method 200 begins with configuring a baseline temperature 202. The default value of the baseline temperature may be 100.4° F. The method 200 includes defining a designated environment 204. After defining the designated environment 204, the method 200 includes defining environment types 206. A single designated environment 26 may have a single or a plurality of environment types. The method 200 includes creating permissions 208. The method 200 includes a step of creating roles 210. While creating roles 210, permissions are assigned those roles. Once roles are created, the method 200 includes adding users 212. After adding users 212, the method 200 includes assigning the users to a workplace 214. While assigning users to a workplace 214, the users are also assigned to a role.

FIG. 31 illustrates a database view 300 on a graphical user interface 106 of users 304 registered for a single designated environment 26. This view may be referred to as a registered user interface 306. The users are accessible via a user menu 302. The registered user interface 306 shows for each user 304 their email 308, first name 310, last name 312, gender 314, active designation 316, and role 318. The registered user interface 306 allows for showing each individual user record 320 via a show link 322. The registered user interface 306 also allows for resetting each individual user record 320 via a reset link 324. A new user 304 can be added via a new record button 326.

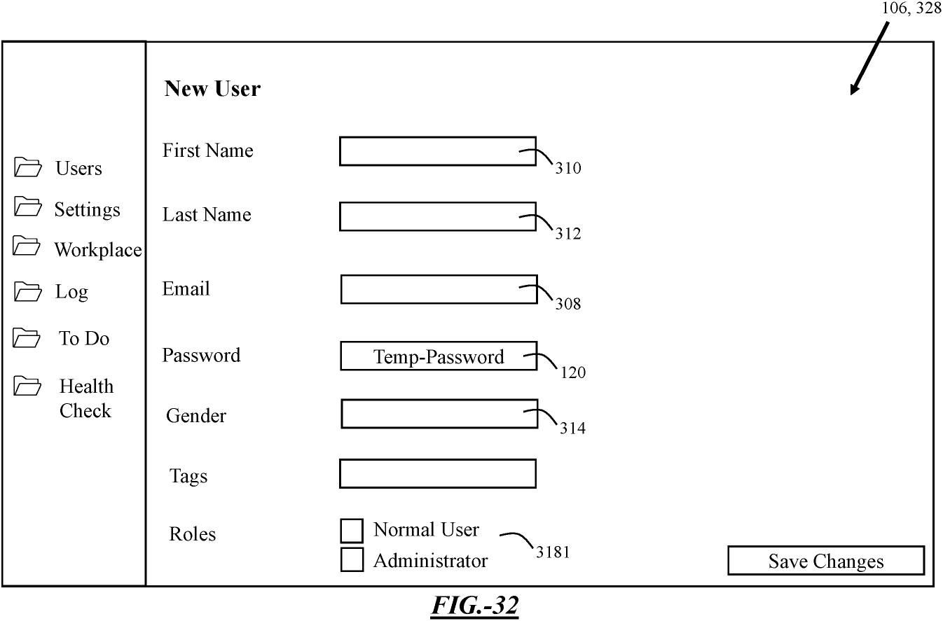

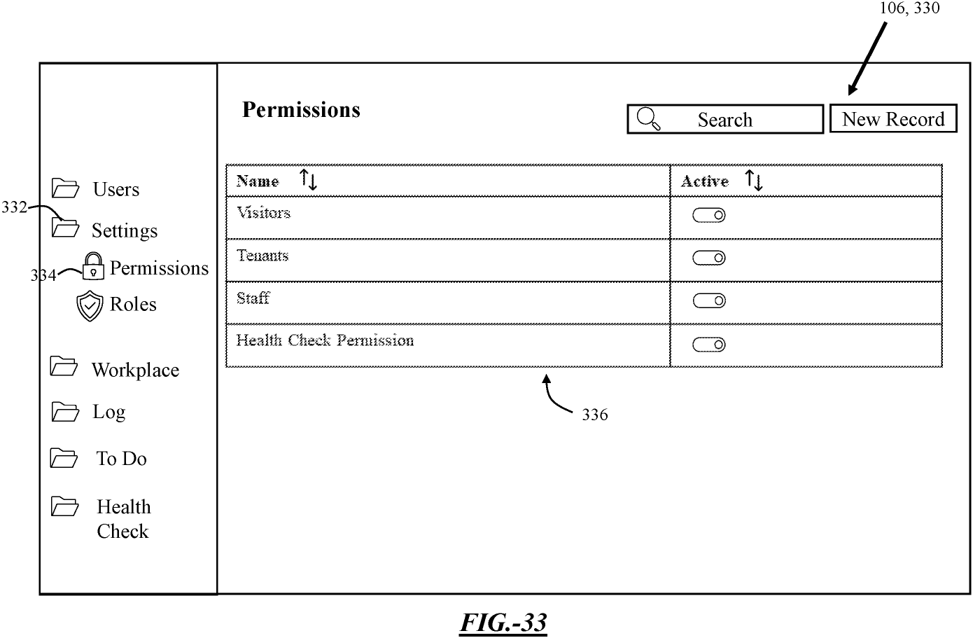

FIG. 32 illustrates a new user input interface 328. The interface is displayed on a graphical user interface 106. The new user input interface 328 provides for inputting of a user’s email 308, first name 310, last name 312, gender 314, and role 318. The new user input interface 328 also provides for generating a password 120.

FIG. 33 illustrates a database view 300 on a graphical user interface 106 of a permissions interface 330. The permissions interface 330 may be accessible via a settings menu 332 and a permissions menu 334. The permissions interface 330 shows different permissions 336 for a designated environment 26.

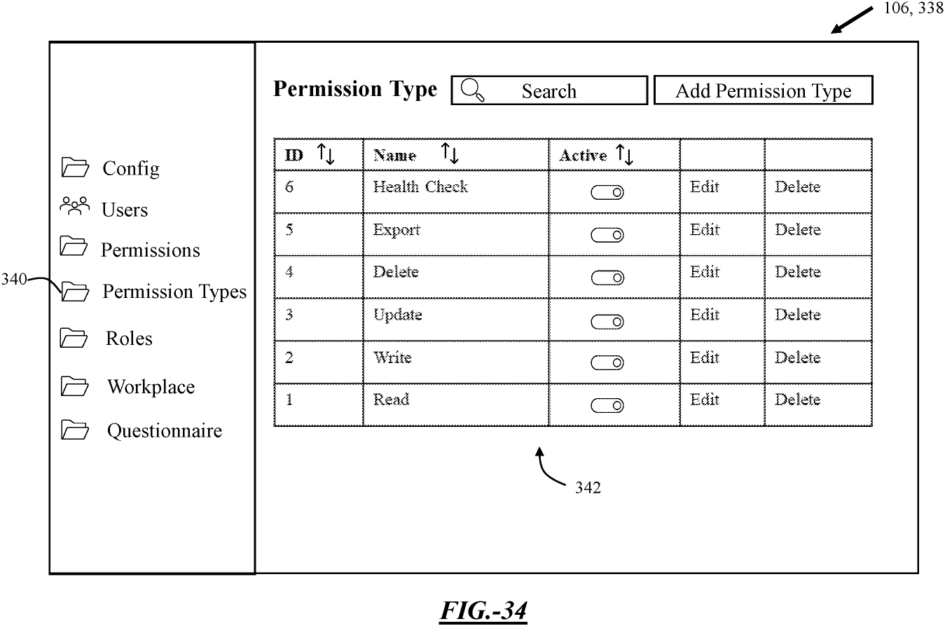

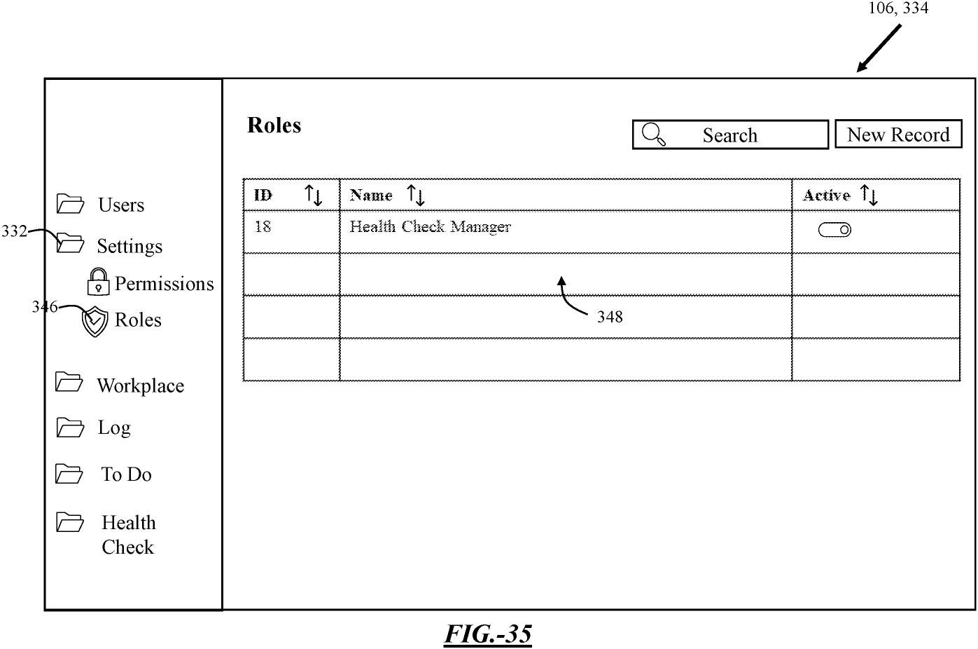

FIG. 34 illustrates a database view 300 on a graphical user interface 106 of a permissions type interface 336. The permissions type interface 336 may be accessible via a permission types menu 340. The permissions type interface 336 includes the varying customizable permission levels 342. Each individual permission 336 is able to have customized combinations of permission levels 342. For example, an administrator may have all permission levels 342 as active.

FIG. 35 illustrates a database view 300 on a graphical user interface 106 of a roles interface 344. The roles interface 344 may be accessible via a settings menu 332 and a roles menu 346. The roles interface 344 displays one or more roles 348. Each role 348 is assigned a designated one or more permissions 336.

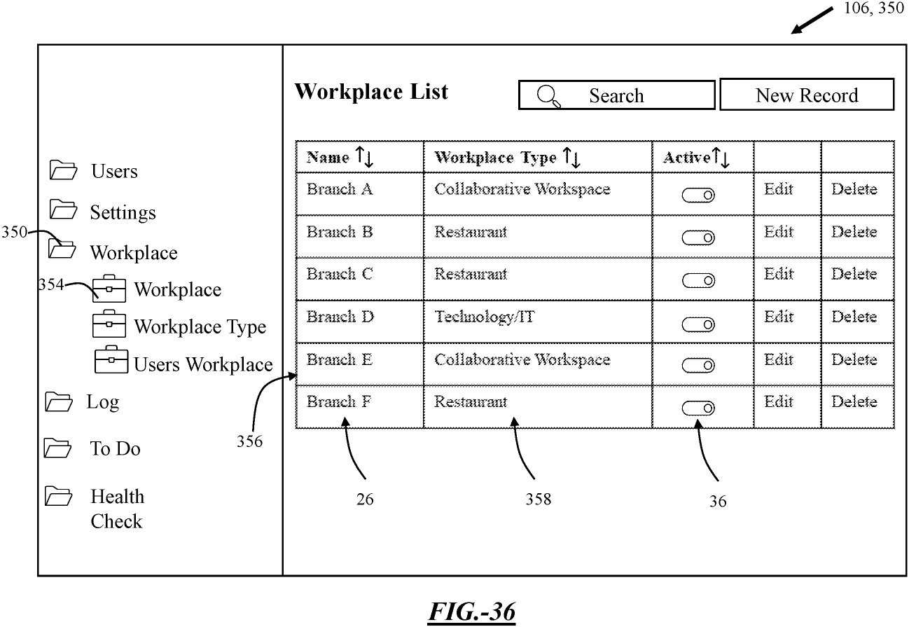

FIG. 36 illustrates a designated environment interface 350 as shown on a graphical user interface 106. The designated environment interface 350 may be accessible via a workplace menu 352 and workplace submenu 354. The designated environment interface 350 lists one or more individual workplace records 356. Each individual workplace record 356 includes a designated environment 26, environment type 358, and active designation 316. Each individual workplace record is able to be edited and/or deleted.

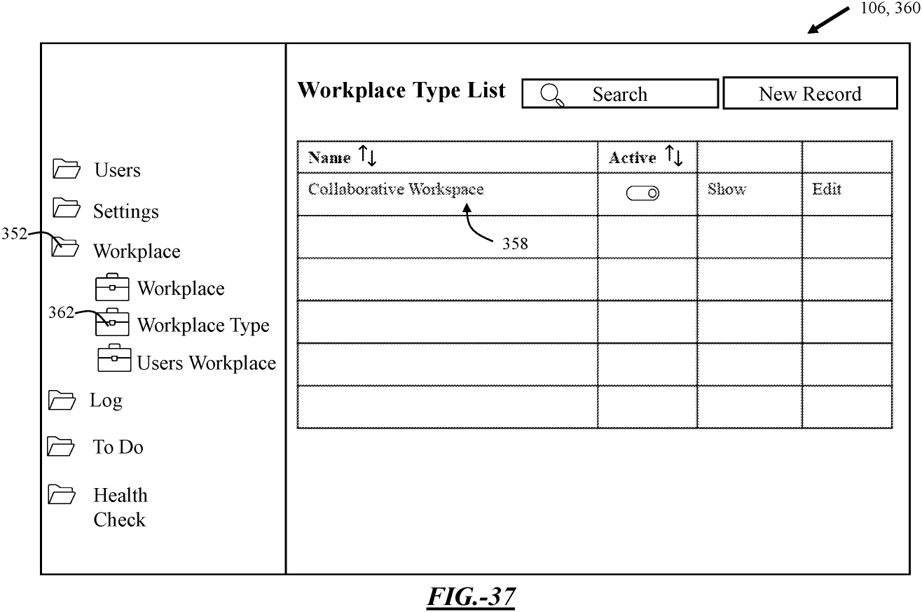

FIG. 37 illustrates an environment type interface 360 as displayed on a graphical user interface 106. The environment type interface 360 may be accessible via a workplace menu 352 and an environment type menu 362. The environment type interface 360 displays one or more environment types 358.

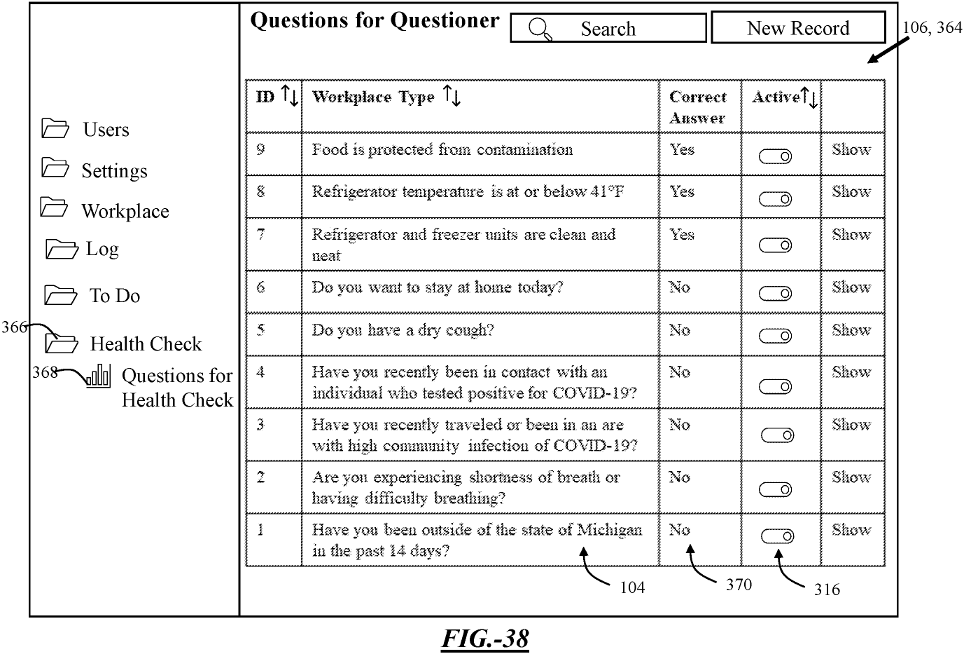

FIG. 38 illustrates a checklist design interface 364. The checklist design interface 364 may be accessible via a health check menu 366 and questions menu 368. The checklist design interface 364 includes a plurality of questions 104. For each question, a desired response 370 is assigned. For each question, there is also an active designation 316.

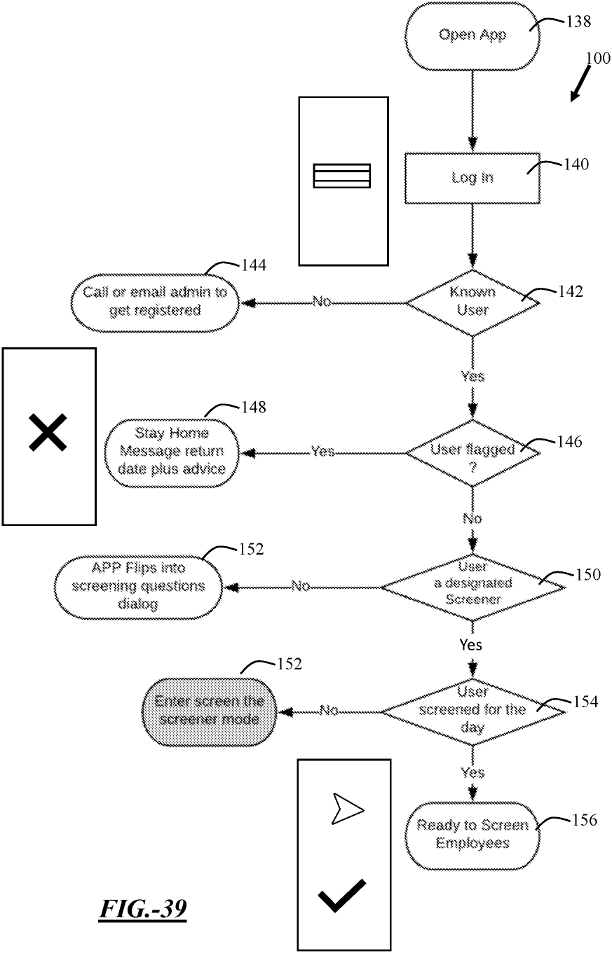

FIG. 39 illustrates a method 100 for identifying and managing the presence of one or more illnesses in an individual. The method 100 includes an individual opening an application 138. After opening the application, the method 100 includes the individual logging in 140 to the application. Upon logging in 140, the method includes a step of authenticating 142. During authenticating 142, if the individual is not recognized as a registered user, the application prompts the user to request access 144. If the individual is not recognized as a registered user, the application does not open any further. If the individual is recognized as a registered user, the method 100 continues to a step of reviewing for flags 146. If the user is flagged in the system due to having presented with one or more illness symptoms or risks, the application delivers a return date notification 148. The return date notification 148 includes a return date based on the date of original symptoms and/or end of symptoms. The return date notification 148 may also include additional advice to the user. If the user is not flagged in the system, method 100 moves on to a step of role determination 150. For example, method 100 during role determination 150 may determine if the user is a designated screener. If the individual is not a designated screener, the method 100 may move onto displaying a questionnaire 152 with a plurality of questions 104. If the individual is a designated screener, the method 100 may move onto a screening check 154. During a screening check 154, the method 100 may include determining if the individual has or has not already been screened for a specific time period, such as the current day. If the individual has not already been screened, the method 100 may move on to displaying a questionnaire 152 with a plurality of questions 104. The questionnaire may be tailored to a screener. If the individual has already been screened, the method 100 moves on to being accessible for additional screening 156.

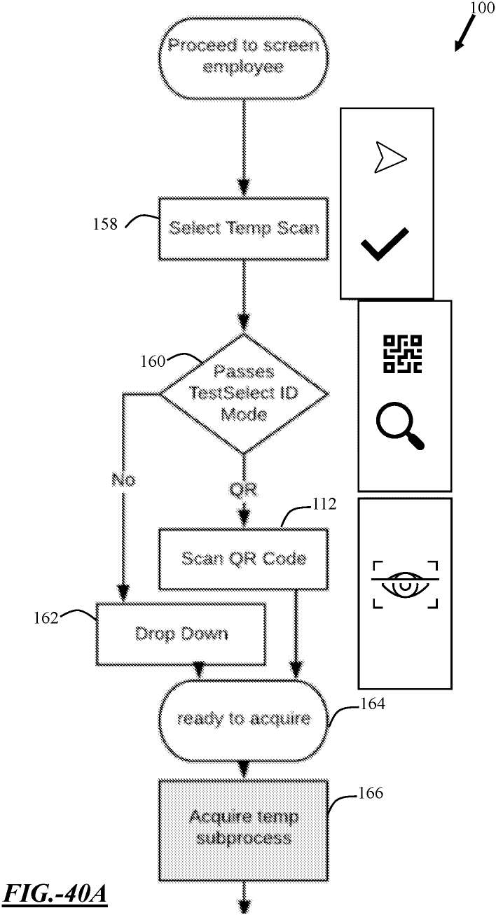

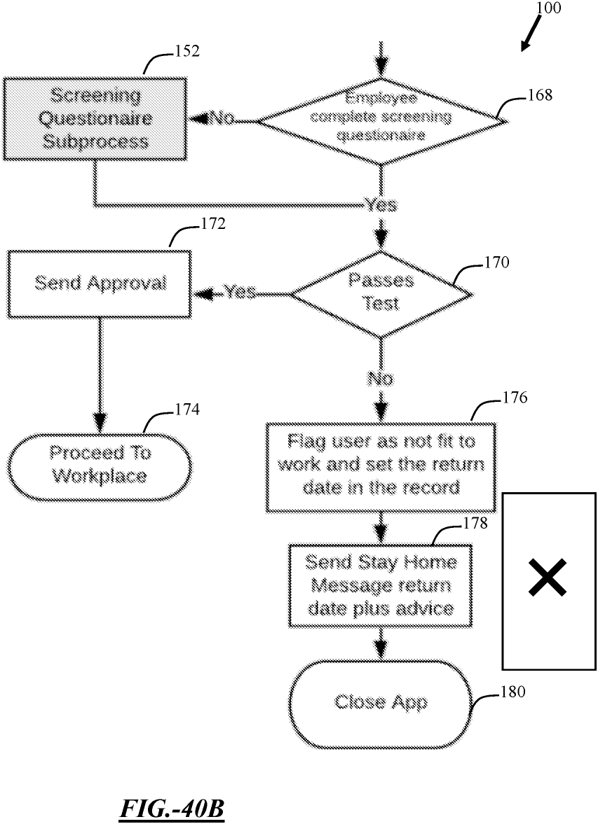

FIGS. 40A to 40B illustrates a method 100 for identifying the presence of one or more illnesses in an individual. The method 100 includes selecting to scan an individual 158. The method 100 includes identifying the individual 160. The individual may be identified by a certification 112, a list of users 162, or other input. After the individual is identified, the method 100 is ready to acquire a body temperature of the individual 164. Once ready, the method 100 includes acquiring a body temperature 166. The method 100 includes a step of questionnaire verification 168. During verification 168, the method 100 determines if the individual being screened has already taken their questionnaire 152 or is still in need of taking. If the user has not taken the questionnaire, they will be prompted to take a questionnaire 152. Once the user has completed both the body temperature acquisition 166 and the questionnaire 152, the method 100 moves to a step of fitness determination 170. During fitness determination 170, the method 100 determines the presence of illness symptoms, risk of exposure to an illness, or both. If no or minimal risk is sound along with no symptoms, the user moves to an approval step 172. During the approval step 172, the individual is identified as safe to enter a designated environment 26 for a specific time period, such as a current day. The individual may then enter into the designated environment 174. If a risk and/or symptom is identified in the user during the fitness determination 170, the individual is flagged 176 within the system 10. The method 100 moves on to establishing a return notification 178. The return notification 178 provides a return date, prompt to return home and avoid the designated environment, or both. Upon finishing the method 100, the application closes 180.

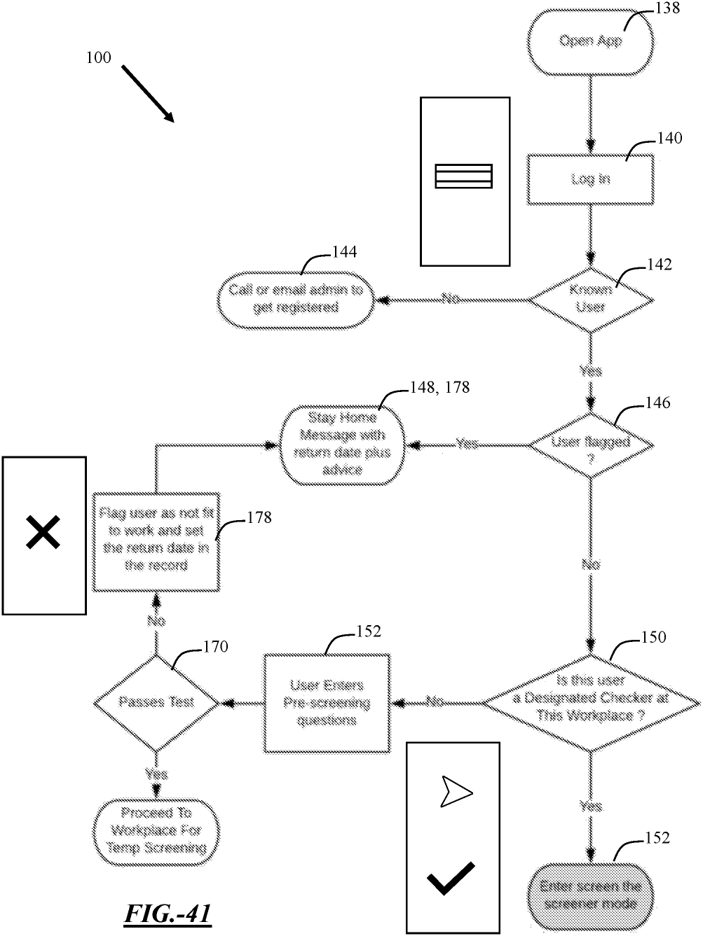

FIG. 41 illustrates a method 100 for identifying and managing the presence of one or more illnesses in an individual. The method 100 includes an individual opening an application 138. After opening the application, the method 100 includes the individual logging in 140 to the application. Upon logging in 140, the method includes a step of authenticating 142. During authenticating 142, if the individual is not recognized as a registered user, the application prompts the user to request access 144. If the individual is not recognized as a registered user, the application does not open any further. If the individual is recognized as a registered user, the method 100 continues to a step of reviewing for flags 146. If the user is flagged in the system due to having presented with one or more illness symptoms or risks, the application delivers a return date notification 148. The return date notification 148 includes a return date based on the date of original symptoms and/or end of symptoms. The return date notification 148 may also include additional advice to the user. If the user is not flagged in the system, method 100 moves on to a step of role determination 150. For example, method 100 during role determination 150 may determine if the user is a designated screener. If the individual is not a designated screener, the method 100 may move onto displaying a questionnaire 152 with a plurality of questions 104. The questionnaire may be tailored to those identified with a specific role or lack thereof, for example, non-screeners. If the individual is identified as a specific role, the method 100 may still move on to displaying a questionnaire 152 with a plurality of questions 104. The questionnaire may be tailored to the individual identified with a specific role, such as a screener. After completing the questionnaire 152, the method may move to a fitness determination 170. If no risks or symptoms were identified via the questionnaire, the fitness determination 170 notifies the individual they may proceed to a designated environment 26. If the fitness determination 170 finds that one or more risks or symptoms are identified from the questionnaire, the method 100 moves to a step of providing a return notification 178.

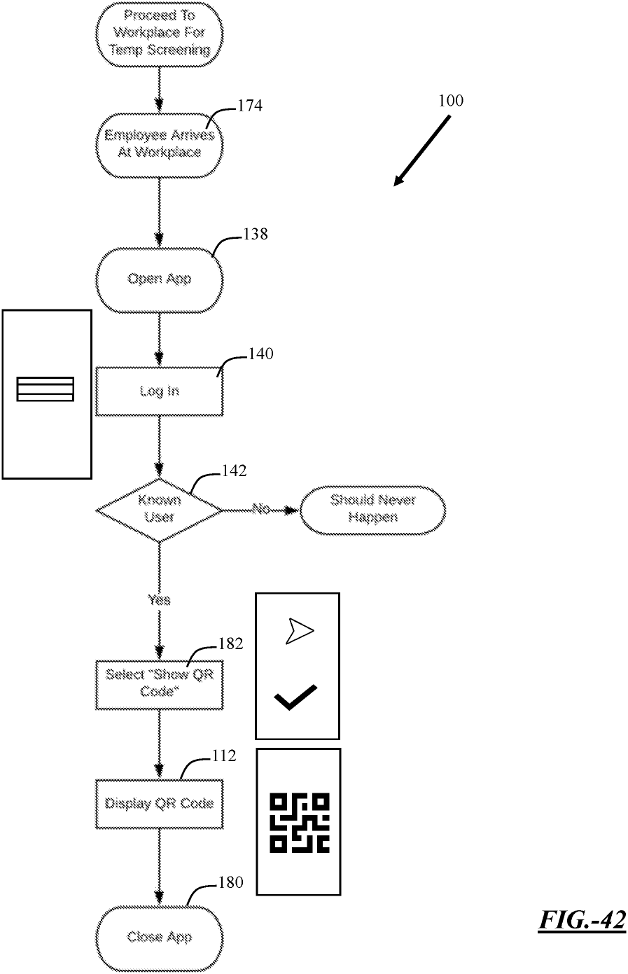

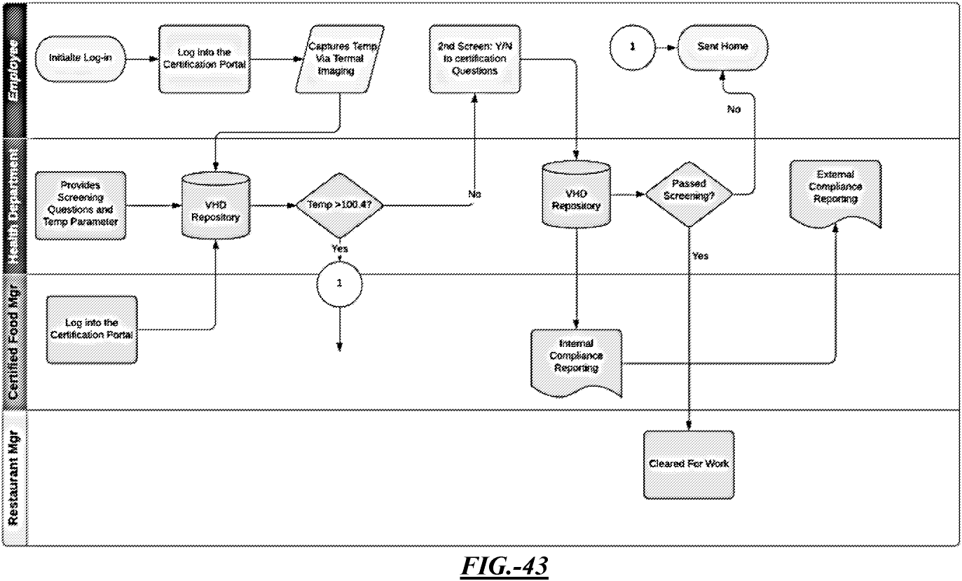

FIG. 42 illustrates a method 100 for identifying the presence of one or more illnesses in an individual. The method may include the individual entering a designated environment 174. The method may include a step of opening the application 138 followed by logging in 140. After logging in, the method 100 moves on to a step of authenticating 142. The method 100 includes a step of displaying certification 182. If the individual has passed one or more fitness determinations for a specific time period, such as a current day, the individual is able to have a certification 112 displayed within the application 32. The certification 112 provides proof the individual has completed the method 100. The method includes closing the application 180.

FIG. 43 illustrates the method 100 for identifying and managing the presence of one or more illnesses in individuals in a shared environment.

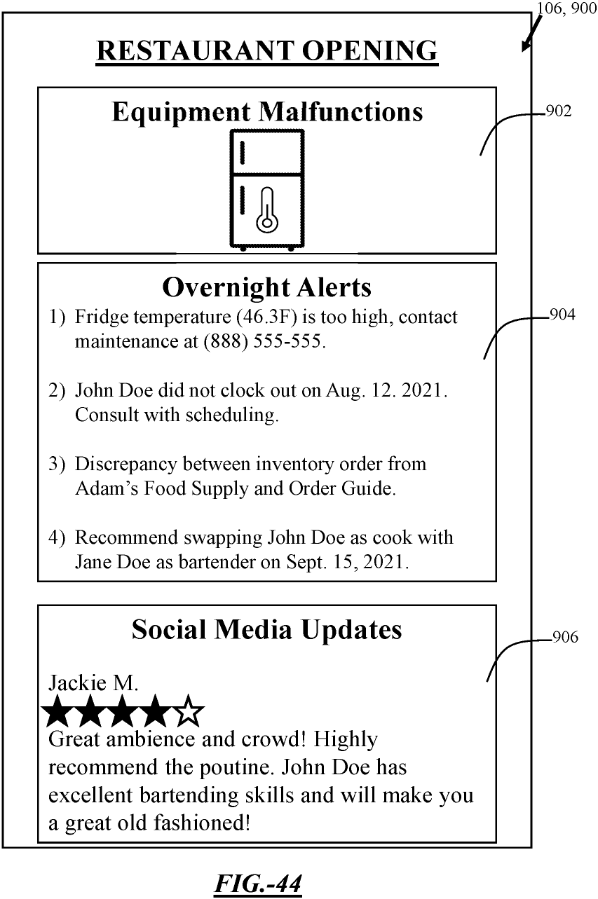

FIG. 44 illustrates a graphical user interface 106 displaying a dashboard 900. The dashboard 900 may display one or more malfunction notifications 902. The one or more malfunction notifications 902 may display one or more equipment malfunctions communicated to the system 10 (not shown), such as through a visual monitoring method. The dashboard 900 may display one or more alerts and/or actions 904. The alerts and/or actions 904 may be triggered via one or more modules and/or methods. For example, as shown, Alert 1 may be generated from a visual monitoring method. For example, as shown, Alert 2 may be generated from a labor module. For example, as shown, Alert 3 may be generated as a discrepancy from one or more invoice quality sub-modules. For example, as shown, Alert 4 may be generated as a staffing change or swap recommendation from a labor module. The dashboard 900 may display one or more social media feeds 906. The system 10 (not shown) may be in communication with one or more social media APIs, search and/or filter for recent posts and/or reviews related to the specific workplace the dashboard is associated with, and display these posts and/or reviews on the dashboard 900.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The terms “generally” or “substantially” to describe angular measurements may mean about +/- 10° or less, about +/- 5° or less, or even about +/- 1° or less. The terms “generally” or “substantially” to describe angular measurements may mean about +/- 0.01° or greater, about +/- 0.1° or greater, or even about +/- 0.5° or greater. The terms “generally” or “substantially” to describe linear measurements, percentages, or ratios may mean about +/- 10% or less, about +/- 5% or less, or even about +/- 1% or less. The terms “generally” or “substantially” to describe linear measurements, percentages, or ratios may mean about +/- 0.01% or greater, about +/- 0.1% or greater, or even about +/- 0.5% or greater.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of, or even consist of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed is:

1. A computer-implemented method for managing labor for a workplace with a labor module comprising:
a) executing a sales sub-module and automatically determining projected sales for the workplace;
wherein the sales sub-module receives one or more external inputs from one or more weather databases, events databases, promotions databases, or a combination thereof;
wherein the sales sub-module executes one or more projected sales algorithms to analyze one or more inputs to determine the projected sales; and
wherein the projected sales algorithm determines one or more sales trends based on one or more weather patterns, one or more events, one or more promotions, one or more calendar data, one or more workplace inputs, or a combination thereof;
b) transmitting the projected sales to a labor sub-module;
c) executing the labor sub-module and determining projected staffing needs;
d) transmitting the projected staffing needs to a scheduling sub-module; and
e) executing the scheduling sub-module and determining one or more recommended staffing actions.

2. (canceled)

3. The computer-implemented method of claim 1, wherein the sales sub-module receives one or more calendar inputs.

4. The computer-implemented method of claim 1, wherein the sales sub-module receives one or more workplace inputs.

5-6. (canceled)

7. The computer-implemented method of claim 1, wherein the labor sub-module is automatically executed upon receiving the projected sales from the sales sub-module.

8. The computer-implemented method of claim 7, wherein the labor sub-module receives one or more staff profile inputs.

9. The computer-implemented method of claim 7, wherein the labor sub-module executes one or more labor algorithms to determine the projected staffing needs.

10. The computer-implemented method of claim 9, wherein the one or more labor algorithms identify what staffing is needed to support the projected sales, what roles need to be fulfilled to support the projected sales, which staff is adequate to support the roles to support the projected sales, or a combination thereof.

11. The computer-implemented method of claim 1, wherein the scheduling sub-module is automatically executed upon receiving the projected sales from the labor sub-module.

12. The computer-implemented method of claim 11, wherein the scheduling sub-module receives one or more scheduling inputs.

13. The computer-implemented method of claim 12, wherein the one or more scheduling inputs include one schedule inputs, one or more attendance inputs, or both.

14. The computer-implemented method of claim 11, wherein the scheduling sub-module executes one or more labor scheduling algorithms.

15. The computer-implemented method of claim 14, wherein the one or more labor scheduling algorithms identify differences between one or more schedules and one or more projected staffing needs, recommends changes in scheduling of employees, recommends changes in roles of scheduled employees, adding hours to scheduled employees, reducing hours of scheduled employees, modifying business hours, or a combination thereof.

16. The computer-implemented method of claim 15, wherein the scheduling sub-module generates one or more staffing action alerts based on the one or more labor scheduling algorithms.

17. The computer-implemented method of claim 16, wherein the one or more staffing action alerts are transmitted from the labor module to an action module of the same system.

18. The computer-implemented method of claim 16, wherein the one or more staffing action alerts are displayed on a user interface of a computing device.

19-116. (canceled)

117. A computer-implemented method for managing labor for a workplace with a labor module comprising:
a) one or more processors executing a sales sub-module and automatically determining projected sales for the workplace;
wherein the sales sub-module receives one or more external inputs from one or more weather databases, events databases, promotions databases, or a combination thereof;
wherein the sales sub-module executes one or more projected sales algorithms to analyze one or more inputs to determine the projected sales; and
wherein the projected sales algorithm determines one or more sales trends based on one or more weather patterns, one or more events, one or more promotions, one or more calendar data, one or more workplace inputs, or a combination thereof;
b) the one or more processors transmitting the projected sales to a labor sub-module;
c) the one or more processors executing the labor sub-module and determining projected staffing needs;
wherein the labor sub-module is automatically executed upon receiving the projected sales from the sales sub-module;
wherein the labor sub-module executes one or more labor algorithms to determine the projected staffing needs;
wherein the one or more labor algorithms identify what staffing is needed to support the projected sales, what roles need to be fulfilled to support the projected sales, which staff is adequate to support the roles to support the projected sales, or a combination thereof;
d) the one or more processors transmitting the projected staffing needs to a scheduling sub-module; and
e) the one or more processors executing the scheduling sub-module and determining one or more recommended staffing actions; and
wherein the scheduling sub-module is automatically executed upon receiving the projected sales from the labor sub-module.

118. The computer-implemented method of claim 117, wherein the scheduling sub-module executes one or more labor scheduling algorithms.

119. The computer-implemented method of claim 118, wherein the one or more labor scheduling algorithms identify differences between one or more schedules and one or more projected staffing needs, recommends changes in scheduling of employees, recommends changes in roles of scheduled employees, adding hours to scheduled employees, reducing hours of scheduled employees, modifying business hours, or a combination thereof.

120. The computer-implemented method of claim 119, wherein the scheduling sub-module generates one or more staffing action alerts based on the one or more labor scheduling algorithms.

121. The computer-implemented method of claim 120, wherein the one or more staffing action alerts are transmitted from the labor module to an action module of the same system.
